(19) United States
(12) Patent Application Publication
(10) Pub. No.: US 2023/0096756 A1
(43) Pub. Date: Mar. 30, 2023

(54) AUTOMATED RISK-ASSESSMENT SYSTEM AND METHODS

(71) Applicant: Balaji SOUNDARARAJAN, Holly Springs, NC (US)

(72) Inventor: Balaji SOUNDARARAJAN, Holly Springs, NC (US)

(21) Appl. No.: 17/484,975

(22) Filed: Sep. 24, 2021

(51) Int. Cl. G06Q 10/06; G06Q 10/08; G06F 3/0482

(52) U.S. Cl. CPC G06Q 10/0635; G06Q 10/087; G06F 3/0482; G06N 7/005

(57) ABSTRACT

Embodiments of the present disclosure include a method for identifying risk of noncompliance in a supply chain. The method includes ingesting, by a risk-assessment system, audit data corresponding an entity, the audit data being in the form of one or more questionnaires; formatting, by the risk-assessment system, the audit data according to a predetermined format where each question within a questionnaire is assigned a corresponding unique code; indexing, by the risk-assessment system, the corresponding unique code for each question of the questionnaire; generating, by the risk-assessment system, a question identifier that includes a concatenation of one or more unique codes for a particular question, such that every question within the questionnaire has a corresponding question identifier; calculating, by the risk-assessment system, a likelihood of a particular violation occurring within the entity in the supply chain by dividing the number of unique identifiers for the particular violation that have a fail response by the total number of unique identifiers for the particular violation; generating, by the risk assessment system, based on the audit data and the calculated likelihood of occurrence, an interactive dashboard; and displaying, by the risk assessment system, the interactive dashboard within a user interface.

### BACKGROUND

Supply chain management is the production and shipment of goods and services between locations. A supply chain may be domestic or international, and may include any number of businesses or locations. At times, domestic and international supply chains may include businesses or locations outside the purview of a company that is outsourcing production of a good. Further, the country of the business or location, within the supply chain, may have a different legal standard with respect to the country of the company outsourcing production or to international norms.

Audits are conducted to assist in determining whether a location or business is acting in accordance with certain standards, including human rights standards, such as child labor, work hours, women's rights, the right to collective bargaining, etc. That a human right violation has occurred, within a supply chain used by an outsourcing company, the outsourcing company may look to other businesses or locations acting in accordance with human-rights standards. Further, the outsourcing company may alter their supply chain to mitigate the violations or avoid reputational harm.

### SUMMARY

Embodiments of the present disclosure include a method for identifying risk of noncompliance in a supply chain. The method includes ingesting, by a risk-assessment system, audit data corresponding an entity, the audit data being in the form of one or more questionnaires; formatting, by the risk-assessment system, the audit data according to a predetermined format where each question within a questionnaire is assigned a corresponding unique code; indexing, by the risk-assessment system, the corresponding unique code for each question of the questionnaire; generating, by the risk-assessment system, a question identifier that includes a concatenation of one or more unique codes for a particular question, such that every question within the questionnaire has a corresponding question identifier; calculating, by the risk-assessment system, a likelihood of a particular violation occurring within the entity in the supply chain by dividing the number of unique identifiers for the particular violation that have a fail response by the total number of unique identifiers for the particular violation; generating, by the risk assessment system, based on the audit data and the calculated likelihood of occurrence, an interactive dashboard; and displaying, by the risk assessment system, the interactive dashboard within a user interface.

Embodiments of the present disclosure further include a method for identifying risk of noncompliance in a supply chain. The method includes ingesting, by a risk-assessment system, audit data corresponding an entity, the audit data being in the form of one or more questionnaires; formatting, by the risk-assessment system, the audit data according to a predetermined format where each question within a questionnaire is assigned a unique code; indexing, by the risk-assessment system, the unique code for each corresponding question of the questionnaire; generating, by the risk-assessment system, a question identifier that includes a concatenation of one or more unique codes for a particular question, such that every question within the questionnaire has a corresponding question identifier; calculating, by the risk-assessment system, a severity of occurrence for a violation occurring in the supply chain by adding a total number of events of a likelihood of the violation occurring, multiplying a criticality level of the severity of the violation by a corresponding numerical value, and then adding each of the multiplied values; generating, by the risk assessment system, based on the audit data and the calculated severity of occurrence, an interactive dashboard; and displaying, by the risk assessment system, the interactive dashboard within a user interface.

A non-transitory computer readable storage medium, storing a computer instruction, wherein the computer instruction, when executed by a computer, causes the computer to perform operations, comprising ingesting, by a risk-assessment system, audit data corresponding an entity, the audit data being in the form of one or more questionnaires; formatting, by the risk-assessment system, the audit data according to a predetermined format where each question within a questionnaire is assigned a unique code; indexing, by the risk-assessment system, the unique code for each corresponding question of the questionnaire; generating, by the risk-assessment system, a question identifier that includes a concatenation of one or more unique codes for a particular question, such that every question within the questionnaire has a corresponding question identifier; calculating, by the risk-assessment system, a severity of occurrence for a violation occurring in the supply chain by adding a total number of events of a likelihood of the violation occurring, multiplying a criticality level of the severity of the violation by a corresponding numerical value, and then adding each of the multiplied values; generating, by the risk assessment system, based on the audit data and the calculated likelihood of occurrence, an interactive dashboard; and displaying, by the risk assessment system, the interactive dashboard within a user interface.

### BRIEF DESCRIPTION OF THE FIGURES

FIG. 1 is an image of an initial visual display, within a user interface of a computing device, that a user may view when using embodiments of the present disclosure, according to an embodiment.

FIG. 2 is a visual display illustrating a ‘Year to Date Summary’ that shows two graphical representations: a Likelihood of Occurrence and a Severity of Occurrence, according to an embodiment.

FIG. 3 shows an in-depth view of a country/factory profile. The profile has a date range and four dropdown menus: Country, City, Factory, and Assessment, for a user to select, which will modify the country/factory profile displayed within the user interface of FIG. 1, according to an embodiment.

FIG. 4 further shows a world map with various countries with colored, circular indicators, from the designations above, for each of the various countries, according to an embodiment.

FIG. 5 illustrates a map of the likelihood of occurrence versus the severity of the violation that occurred, according to an embodiment.

FIG. 6 shows a chart indicating the Geographical Risk according to a selectable criteria, including Countries, Designations, Industries, Issue Types, and Sub-headers, according to an embodiment.

FIG. 7 shows a plot indicating the Auditor Scoring Pattern and the Number of Assessments for particular auditors, with respect to the likelihood to fail a particular issue, according to an embodiment.

FIG. 8 illustrates a table showing the Likelihood by Designation for various issues, including Hours of Work, Facility Security, Environment, Health and Safety, Worker Residence, Women's Rights, Forced Labor, Child Labor, etc., according to an embodiment.

FIG. 9 includes a table listing additional issue types and corresponding sub-headers, according to an embodiment.

FIG. 10 displays interactive maps regarding auditor performance that includes a similar chart from FIG. 7, the auditor scoring pattern plotted against the number of assessments, according to an embodiment.

FIG. 11 illustrates a profile of the Likelihood and Impacts Trends, showing two charts: a Trend & Forecast of Likelihood chart and a Trend of Severity chart, according to an embodiment.

FIG. 12 illustrates a profile for the Trend and Forecast of Total Risk for Selected Issue Type, according to an embodiment.

FIG. 13 illustrates the risk-assessment system architecture, including a database layer, a processing layer, and a visualization layer, according to an embodiment.

FIG. 14 shows a process for the risk-assessment system generating a question/severity map that indexes the questionnaires submitted by an auditor, according to an embodiment.

FIG. 15 illustrates a process of mapping audit details from FIG. 30, from the questionnaire to a question/severity map, according to an embodiment.

FIG. 16 illustrates a process of the risk-assessment system uniquely identifying each response (e.g., ‘pass’, ‘fail’, or ‘not applicable’) for a particular question within an audit, according to an embodiment.

FIG. 17 illustrates a process of discarding questions that do not include certain questions (e.g., questions that include a response, “not applicable”, or any portion of the unique identifier, etc.) calculating a risk metric for the likelihood of occurrence, according to an embodiment.

FIG. 18 illustrates a process of calculating a risk metric for the likelihood of occurrence, according to an embodiment.

FIG. 19 illustrates the process of continuing calculating the risk metric for a “likelihood of occurrence” by filtering the unique identifiers by the response, “pass” or “fail, according to an embodiment.

FIG. 20 illustrates the process for the risk-assessment system calculating the risk metric to create a value for a “severity of occurrence”, according to an embodiment.

FIG. 21 illustrates a process for the risk-assessment system continuing to calculate the severity of occurrence for only the stored identifiers that have an associated violation severity, according to an embodiment.

FIG. 22 illustrates a process for the risk-assessment system to calculate a weighted sum of the aggregated severity level by multiplying numerical values with the severity level of a violation and adding the individual multiplied values, according to an embodiment.

FIG. 23 illustrates an entity relationship diagram that details how many one-to-many relationships the risk-assessment system creates, according to an embodiment.

FIG. 24 illustrates a table for the question severity map, that includes ID, questionnaire, question, response, issue type, sub-header, criticality, and question identifier columns, according to an embodiment.

FIG. 25 shows a table for the likelihood relationship created based on the question/severity map, that includes account ID, assessment ID, normalization designation/status, Qcode (question code) from audit details, encoded response, and Qcode from question/severity map columns, according to an embodiment.

FIG. 26 illustrates a table that is a result of filtering table to remove the rows without a likelihood code, according to an embodiment.

FIG. 27 illustrates multiple tables used by the risk-assessment system to calculate an overall likelihood of occurrence and a likelihood of occurrence, with respect to a criteria, according to an embodiment.

FIG. 28 illustrates the tables used by the risk-assessment system in calculating a severity of occurrence score, according to an embodiment.

FIG. 29 illustrates the various ways the risk-assessment system may utilize statistical techniques to forecast a likelihood of occurrence for a particular issue for a range of time, as described in FIGS. 11 and 12, according to an embodiment.

FIG. 30 shows multiple tables created and used in the calculations of the likelihood of occurrence and the severity of occurrence, as discussed above, including a question/severity map, audit details, active factories, and the key that is used to create relationships between the tables, according to an embodiment.

FIG. 31 shows multiple tables used by the risk-assessment system to calculate the likelihood of occurrence, as discussed above, including the question/severity map, audit details, active factories, the likelihood of occurrence calculation table, the likelihood of occurrence unique distinct identifier calculation table, and the key, according to an embodiment.

FIG. 32 shows multiple tables used by the risk-assessment system, after filtering the “failed” responses from the “pass” responses, to calculate the severity of occurrence, according to an embodiment.

FIG. 33 shows the metric name and the associated formula for calculating the particular metric, according to an embodiment.

FIG. 34 shows a metric name and an associated formula for calculating the particular metric, according to an embodiment.

### DETAILED DESCRIPTION OF THE EMBODIMENTS

In supply chain management, a company may rely on a labor force that is located a distance where oversight of the entity (e.g., a workplace, factory, etc.; hereinafter “workplace” and “entity” are used interchangeably, however, embodiments of the present disclosure relate to “entities” broadly, which include workplaces, factories, manufacturing facilities, corporations, or group(s) of people associated with a supply chain, and/or any entity that is regulated by international and national customs/laws) workplace, or the workforce is not feasible, and random or regular audits are conducted to evaluate workplace conditions, product quality and other forms of compliance. Human rights and environmental violations at workplaces, where a company relies on its production, can be a grave concern for the company. Audits of the workplace may increase the likelihood that the company will be aware of human-rights and environmental violations, but visualizing and determining, in advance—based on predictions using historical data—will help the company make correct decisions for selecting future workplaces in a supply chain. Embodiments of the present disclosure present a risk-assessment system that can generate an interactive dashboard that presents a graphical display of a likelihood of occurrence and a severity of occurrence for particular workplace and environmental violations, with respect to such factors as region (such as city, country, factory, etc.), industry, assessment, auditor, etc. Further, the risk-assessment system can filter out auditor bias.

Audits include some degree of subjectivity, which may be introduced by factories (e.g., a factory may alter their workplace to conform with regulatory requirements prior to an audit, then change the workplace back to before the audit) or by auditors (e.g., regulations may introduce subjective evaluations, or an auditor may perceive the language of a regulation differently than other auditors). For example, if identical factories with identical workplace conditions, within the same country, are audited by different auditors, the audit may result in the auditors providing different responses for identical questions. This may provide an altered view of when a workplace is violating a particular regulation or human right, which may lead to a workplace with poor working conditions not in violation or a workplace with proper working conditions in violation of a law, regulation, or international custom. Here, the risk-assessment system provides a neutral analysis of workplace conditions by normalizing any ingested data by comparing data provided by different auditors, different audit types, and taking into consideration such factors as different countries, cities, workplaces, regulations, etc. Further, the risk-assessment system allows a user to grade an auditor based on an assessment of an auditor and all corresponding audit data ingested by the auditor; or the risk-assessment system may automatically grade the auditor based on the ingested audit data.

Embodiments may include a risk-assessment system ingesting audit assessments (e.g., in the form of questionnaires) completed by auditors. The risk-assessment system may format the questionnaire into its basic components, such as question, response—‘pass’/‘fail’ issue (or violation) type (such as child labor, women's rights, long hours, etc.), factory, etc. The risk-assessment system may then index the formatted questionnaire according to a unique question identifier that is a concatenated string of the formatted categories for the particular question. For example, the concatenated string may take the form of ‘questionnaire-question-response’. The risk-assessment system then can calculate both a likelihood of occurrence for a particular issue type (violation) based on the audit data and a severity of the occurrence of the particular issue type based on the audit data.

After calculating the likelihood of occurrence for a particular issue type and a severity of the occurrence of the particular issue type, the risk-assessment system may generate an interactive dashboard, within a graphical interface, that shows a map and/or visual representation (e.g., one or more tables) of the likelihood of occurrence and a severity of occurrence with respect to various factors, including region, issue type, factory, etc. The risk-assessment system may receive user input to adjust the map and/or visual representation, according to factors (e.g., date range, location, etc.). Further, the risk-assessment system may forecast, by statistically analyzing the historical data, the likelihood of occurrence of a particular issue type several months (or longer) in advance.

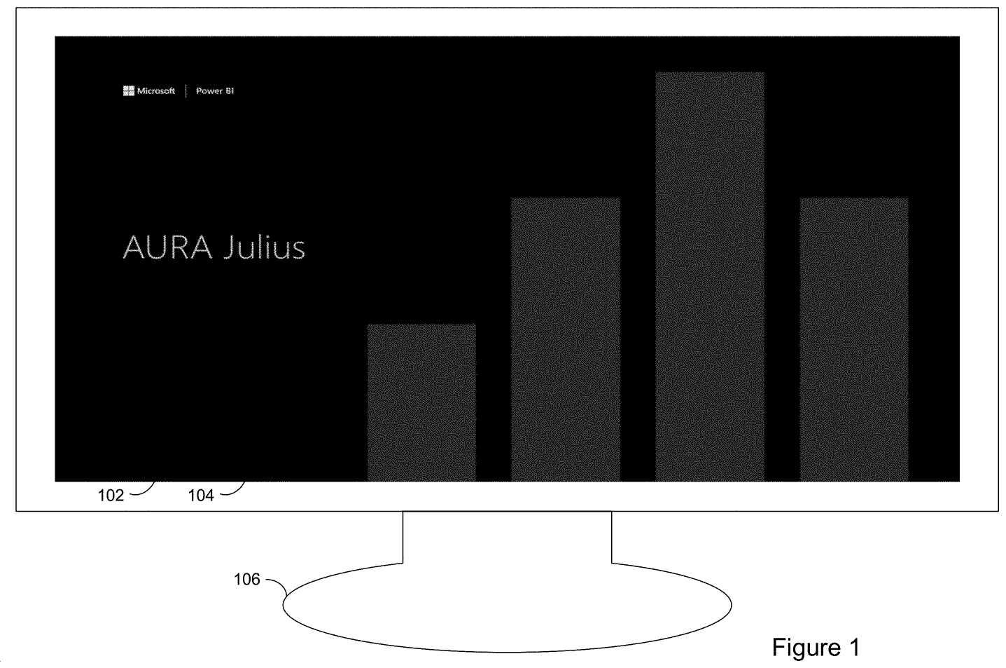

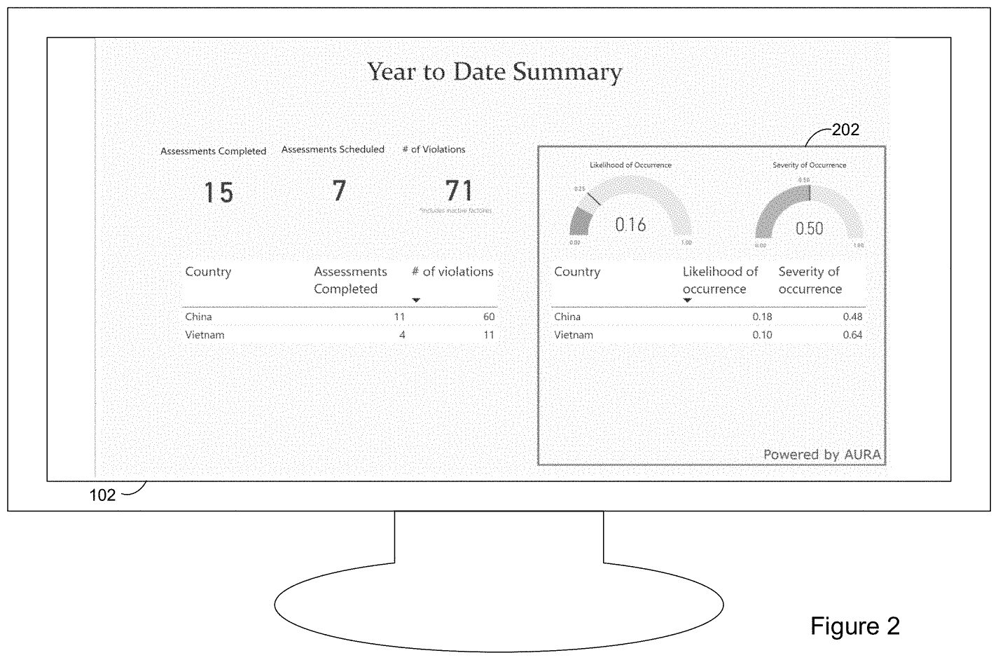

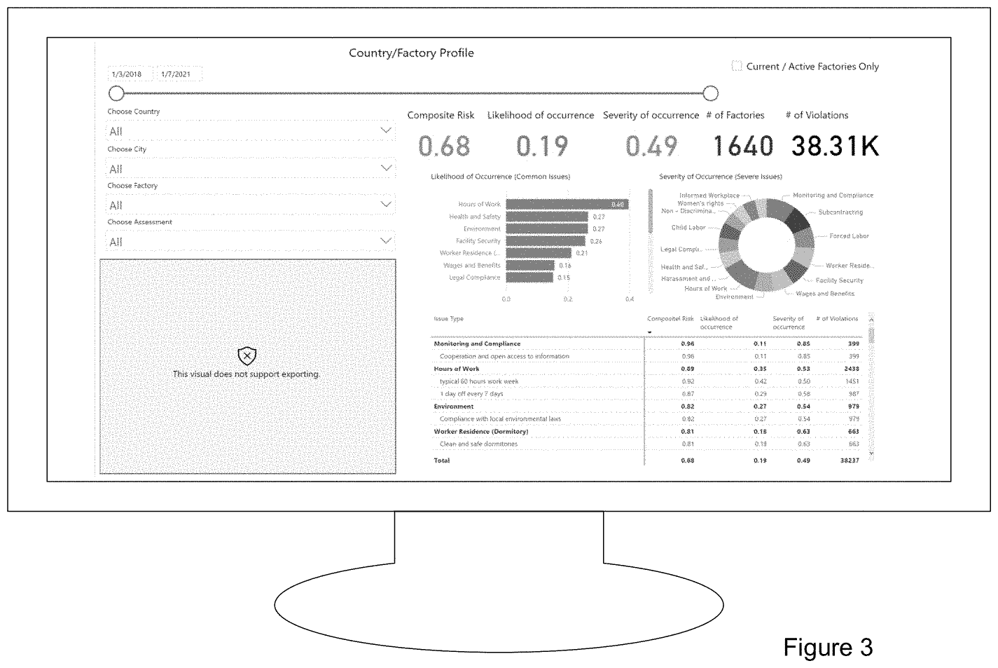

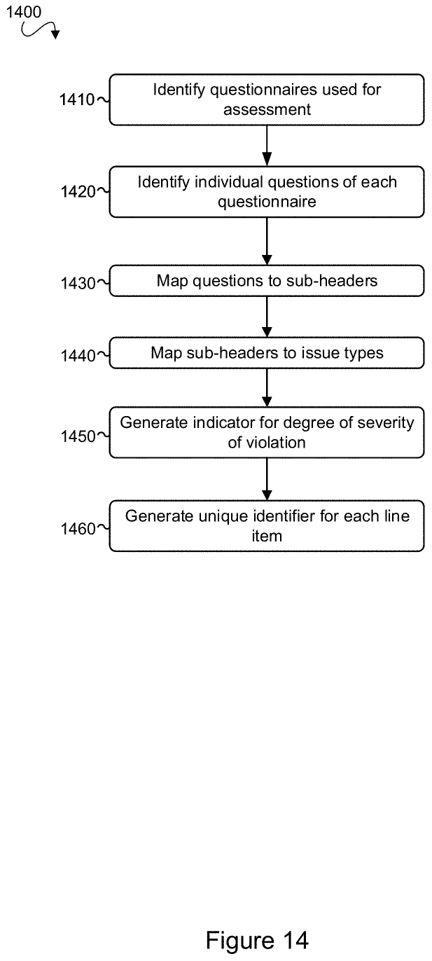

FIG. 1 is an image of an initial visual display 102, within a user interface 104 of a computing device 106, that a user may visualize when beginning to use embodiments of the present disclosure. FIG. 2 is the visual display 102 illustrating a ‘Year to Date Summary’ that shows, within box 202, two graphical representations: a Likelihood of Occurrence and a Severity of Occurrence. The likelihood of occurrence stands for the likelihood that a particular type of violation (e.g., child labor, wages below a legal limit, illegal hours, etc.) will occur and the severity of the occurrence stands for the severity of the violation that may occur, which are both based on completed assessments ingested by the risk-assessment system (e.g., risk-assessment system 1300, FIG. 3). FIG. 2 further shows the number of assessments completed (15), the number of assessments scheduled (7), and the number of violations within the assessments (71). The assessments scheduled may be taken from an audit schedule stored within the database layer 1302 of the risk-assessment system 1300. Below that, FIG. 2 shows the Country where the assessments were completed and the corresponding number of violations in each country (60 in China and 11 in Vietnam). Referring back to box 202, the likelihood of occurrence and the severity of occurrence can be calculated (as described in FIGS. 14-28) from the historical data collected from the assessments completed. As shown, the likelihood of occurrence of a violation is 0.16 and the severity of the occurrence of any violation is 0.5, which may be referred to below as moderate, on a scale from low to moderate to high.

FIG. 3 shows an in-depth view of a Country/Factory profile. The profile has a date range, from Jan. 3, 2018 to Jan. 7, 2021 and four dropdown menus: Country, City, Factory, and Assessment, for selection by a user, which will modify the Country/Factory profile displayed within the user interface. For example, if a country (India) is selected, the risk-assessment system 1300 will adjust the likelihood of occurrence and the severity of occurrence so that only audit assessments of factories located in India are displayed within the user interface. FIG. 3 further shows a Composite Risk (0.68), which is the sum of the Likelihood of Occurrence (0.19) and the Severity of Occurrence (0.49). The number of factories (1640) is shown, which lists the number of factories from “All” selected from each of the dropdown menus (Country, City, Factory, and Assessment), from Jan. 3, 2018 to Jan. 7, 2021. And the number of total violations from previous criteria is 38,310.

FIG. 3 further breaks down, as illustrated with a bar graph, the various common issues (violations) that occurred with respect to the above criteria (Hours of Work, Health and Safety, Environment, etc.) and, additionally, breaks down, as illustrated with a circle graph, the severity of the issues (violations) that occurred (Forced Labor, Child Labor, Women's Rights, etc.). Below that, a table lists some of the issue types and the corresponding likelihood of occurrence, severity of occurrence, number of violations, and composite risk. Further, each issue is broken down into sub-headers that lists the specific issues of the broader category of each issue. For example, the issue, Hours of Work, has two sub-headers, typical 60 hours work week and 1 day off every 7 days. The Country/Factory Profile is not limited to the visual interface illustrated in FIG. 3 and may include embodiments not shown.

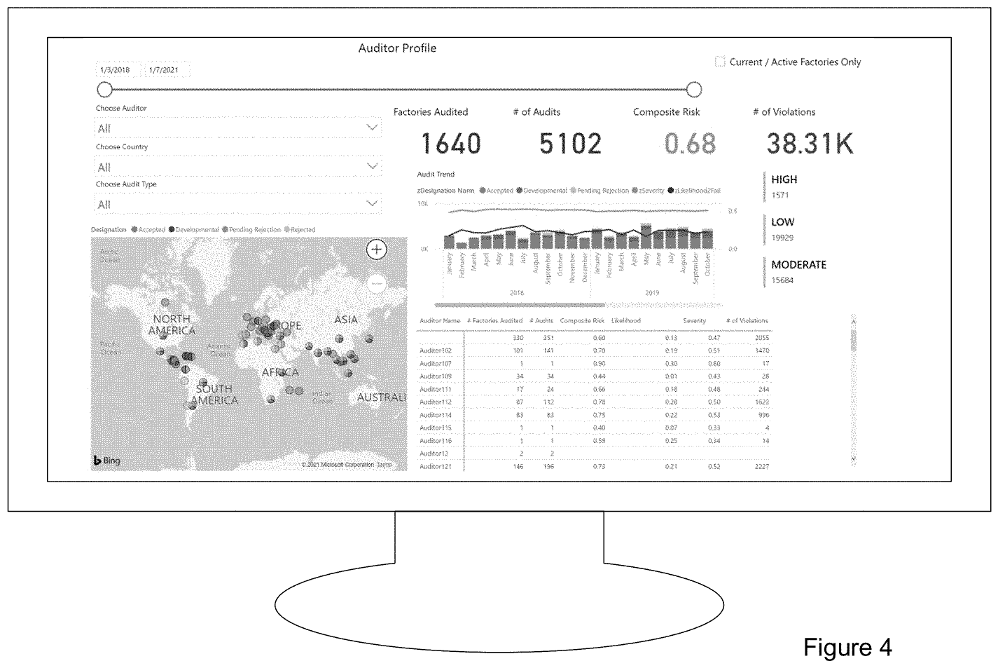

Even though a question used for an audit may have a binary response, auditors may inject their own subconscious biases into the audit based on a subjective view of the criteria resulting in the response. For example, even considering a very detailed criteria for determining whether a violation receives a “pass” or “fail”, auditor's perception and bias may result in a factory receiving a “pass” from one auditor and a “fail” from another auditor, for the same violation. Categorizing the audit data according to an auditor may isolate auditor bias, or at least flesh out auditor bias. FIG. 4 illustrates a view of an Auditor Profile, displaying the same date range as from FIG. 3, same number of factories audited, composite risk, number of violations; however, the number of audits is listed (5102) and the number of dropdown menus is three: (Auditor, Country, and Audit type). The auditor may be from a selection of authorized auditors, who have submitted assessments. The audit type may include the purpose of the audit. The bar graph in month-intervals includes five designations (zDesignation Norm): Accepted (turquoise), Developmental (gray), Pending Rejection (yellow), zSeverity (orange), and zLikelihood2Fail (blue). The Accepted designation is the number of audits that were accepted into the risk-assessment system (discussed below); the Developmental designation is the X; the Pending Rejection designation is the number of audits that are pending as rejected; the zSeverity designation is the severity of any issues (violations) occurring; and the zLikelihood2Fail designation is the likelihood of failing an issue. As can be seen, the zSeverity is roughly 0.49 and the zLikelihood2Fail is roughly 0.19, both measurements are as shown in FIG. 3. Right of the bar graph is the severity range of low (19,929), moderate (15,684), and high (1,571), and the corresponding number of each severity for the total violations.

FIG. 4 further shows a world map, with colored, circular indicators, from the designations above, for various countries, where an audit has been performed. To the right is shown a table with columns for the Auditor Name, Number of Factories Audited, Number of Audits, Composite Risk, Likelihood of Occurrence, and the Severity of Occurrence. Each row lists an auditor along with information pertaining to the other columns.

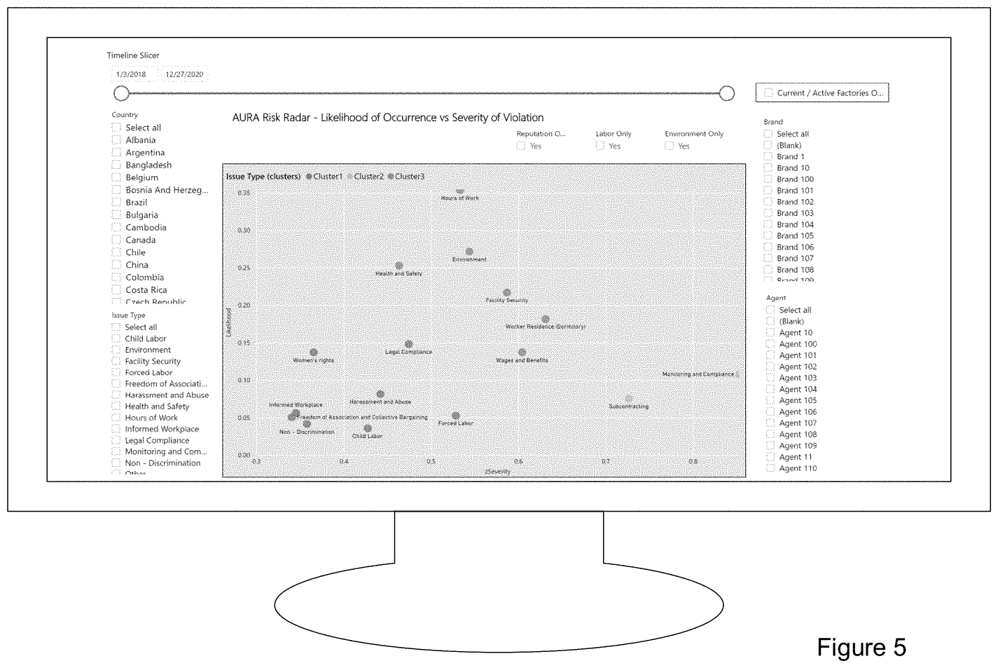

FIG. 5 illustrates a map of the likelihood of occurrence versus the severity of the violation that occurred, where the plots are clustered by issue type. As shown, the chart may be adjustable from a user-selection of various countries, issue type, brand, and agent. The issue types are clustered and indicated in various colors (turquoise, red, and yellow). For example, Cluster 1 is turquoise and includes women's rights, legal compliance, harassment and abuse, forced labor, informed workplace, non-discrimination, freedom of association and collective bargaining, and child labor; Cluster 2 is yellow and includes subcontracting, and monitoring and compliance; Cluster 3 is red and includes health and safety, environment, facility security, worker residence, and wages and benefits. In addition, FIG. 5 shows three options: to select Environmental Only, Labor Only, and Reputation Only, for viewing the issues within the chart.

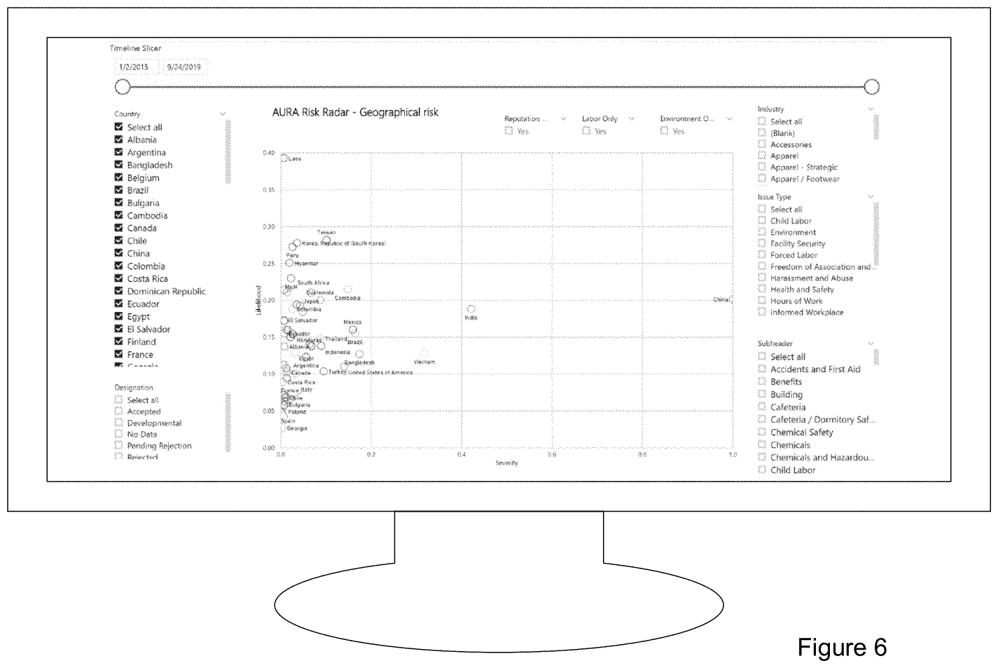

FIG. 6 shows a chart indicating the Geographical Risk, from Jan. 2, 2015 to Sep. 24, 2019, according to a selectable criteria, including Countries, Designations, Industries, Issue Types, and Sub-headers (e.g., benefits, chemical safety, child labor, etc.). Similar to FIG. 5, the Geographical Risk chart can be filtered according to three options: Environmental Only, Labor Only, and Reputation Only, for viewing the issue types within the chart. FIG. 6 further shows the plots within the chart are a different style than in FIG. 5, and show colored circles that are not filled in.

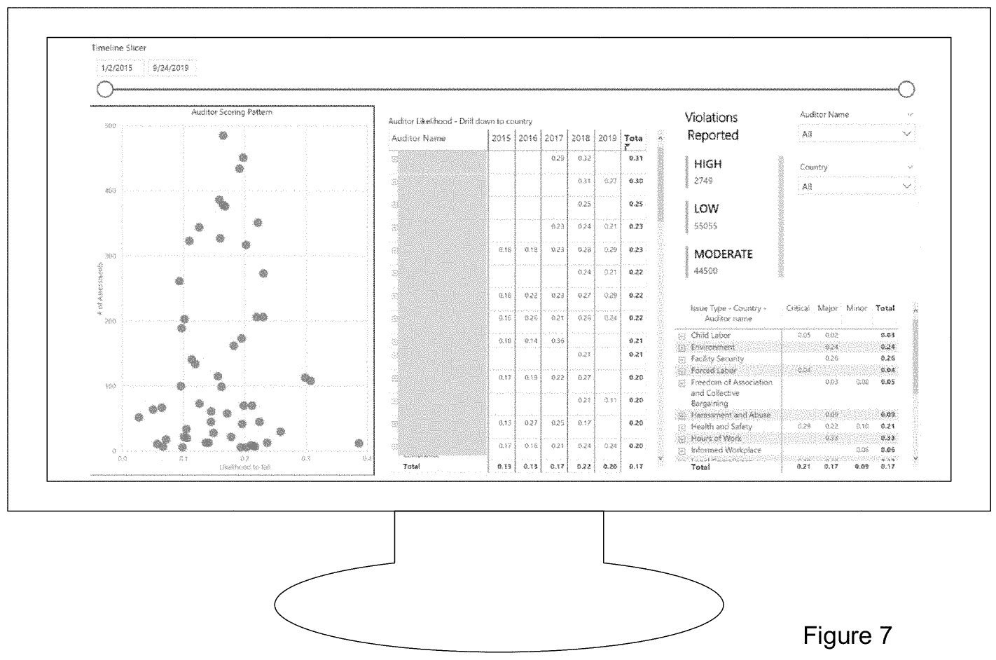

FIG. 7 shows a plot indicating the Auditor Scoring Pattern and the Number of Assessments for particular auditors, with respect to the likelihood to fail a particular issue. A table with columns including Auditor Name and scores for years, ranging from 2015-2019. Further, the violations reported, and the severity level for each particular violation, is shown, low (55,055), moderate (44,500), and high (2,749). The severity level may be an automatic designation based on a criteria or selected by an authorized user (as discussed below). In addition, two drop-down menus for narrowing the display, according to Auditor Name and Country, are shown. Below that, a table illustrates auditor scores according to issue type and country.

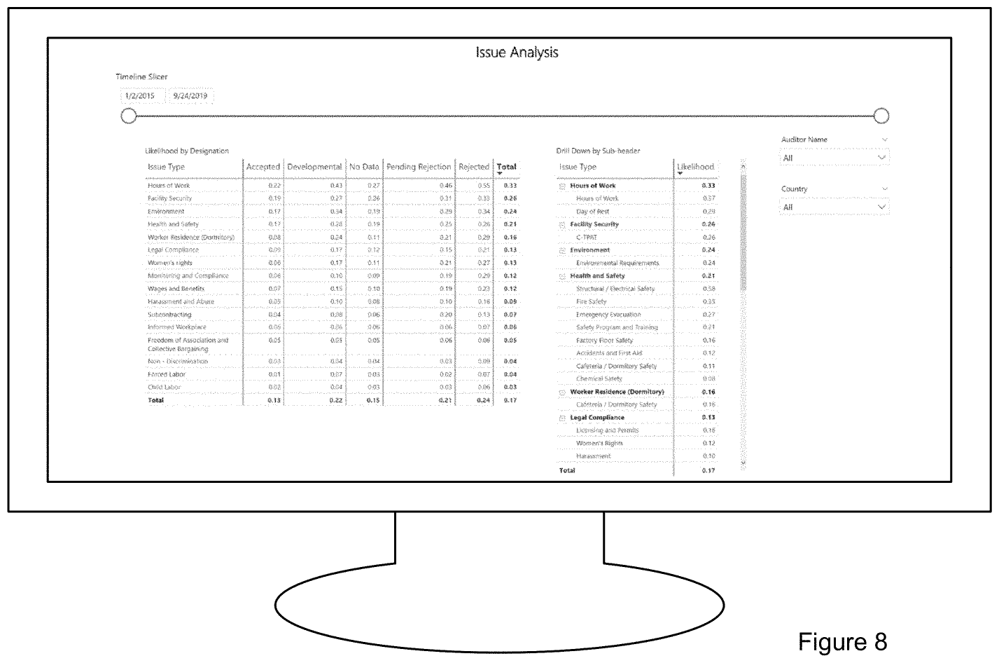

Turning to FIG. 8, a table, with dates ranging from Jan. 2, 2015 to Sep. 24, 2019, illustrates a table for Likelihood by Designation for various issues, including Hours of Work, Facility Security, Environment, Health and Safety, Worker Residence, Women's Rights, Forced Labor, Child Labor, etc. FIG. 8 further shows another table with a more in-depth view of each issue type from the previous table by having each sub-header of the issue types, and their corresponding likelihood scores, listed. For example, the table includes issue type: Health and Safety and the sub-headers: Structural/Electrical Safety, Fire Safety, Emergency Evacuation, etc. The two tables within FIG. 8 may be refined according to the two dropdown menus located at the right showing the Auditor Name and Country.

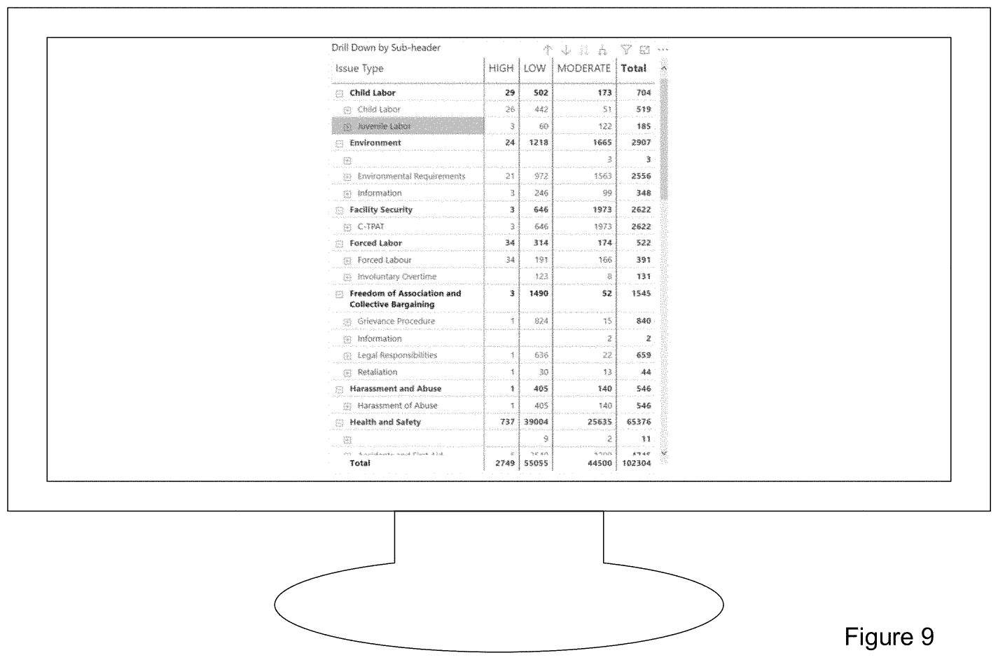

FIG. 9 includes a table listing additional issue types and corresponding sub-headers, along with their respective severity level, designated as low, moderate, or high. For example, the Child Labor issue type has two sub-headers: child labor and juvenile labor. The child labor may correspond to a first age range (e.g., 7-12 years old) while the juvenile labor may correspond to a second age range (e.g., 13-17 years old). Likewise, the issue type, Freedom of Association and Collective Bargaining, has four sub-headers: Grievance Procedures, Information, Legal Responsibilities, and Retaliation, and each has corresponding severity levels.

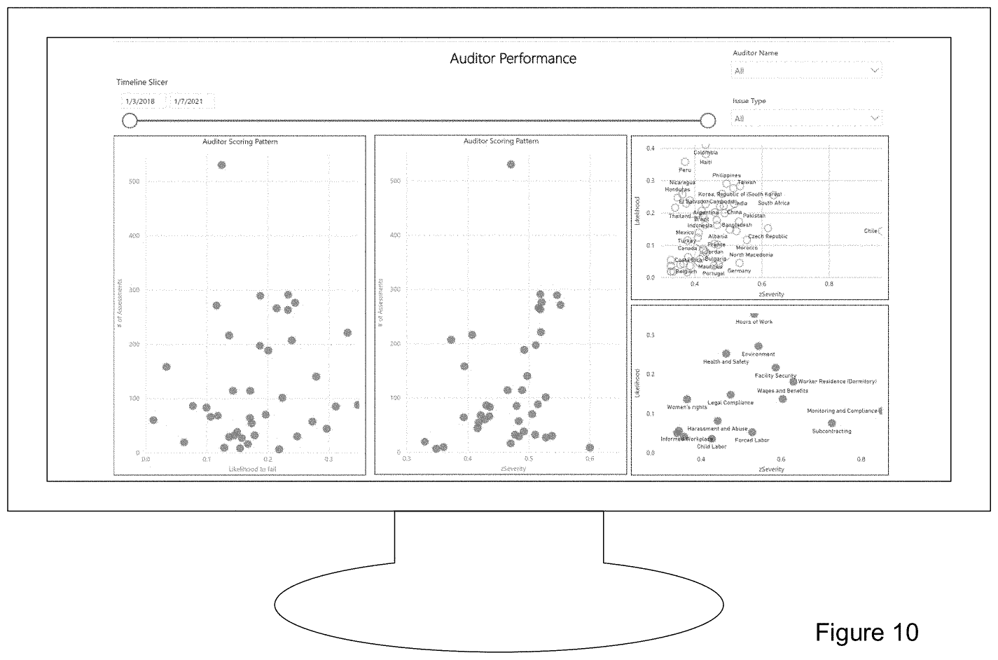

FIG. 10 displays four interactive maps relating to auditor performance, from Jan. 3, 2018 to Jan. 7, 2021, that include a similar chart as shown in FIG. 7: the Auditor Scoring Pattern showing the Number of Assessments plotted against the Likelihood to Fail or the Severity of the Issue. The two charts on the right show the likelihood to fail particular issues plotted against the severity of the issue failed, one of the countries where the auditor has made assessments and the other with regard to particular issues.

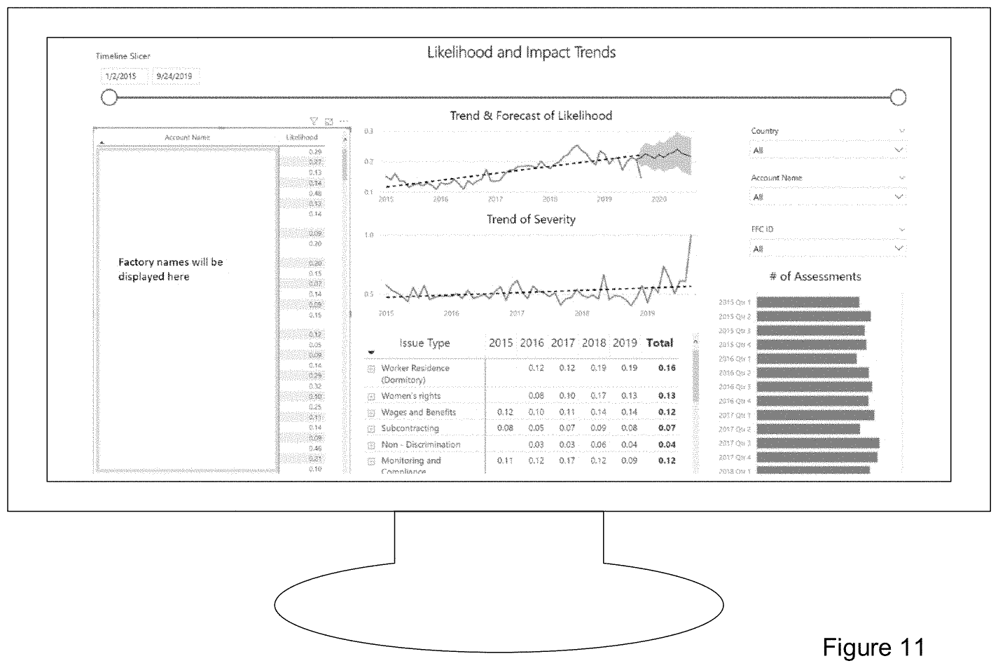

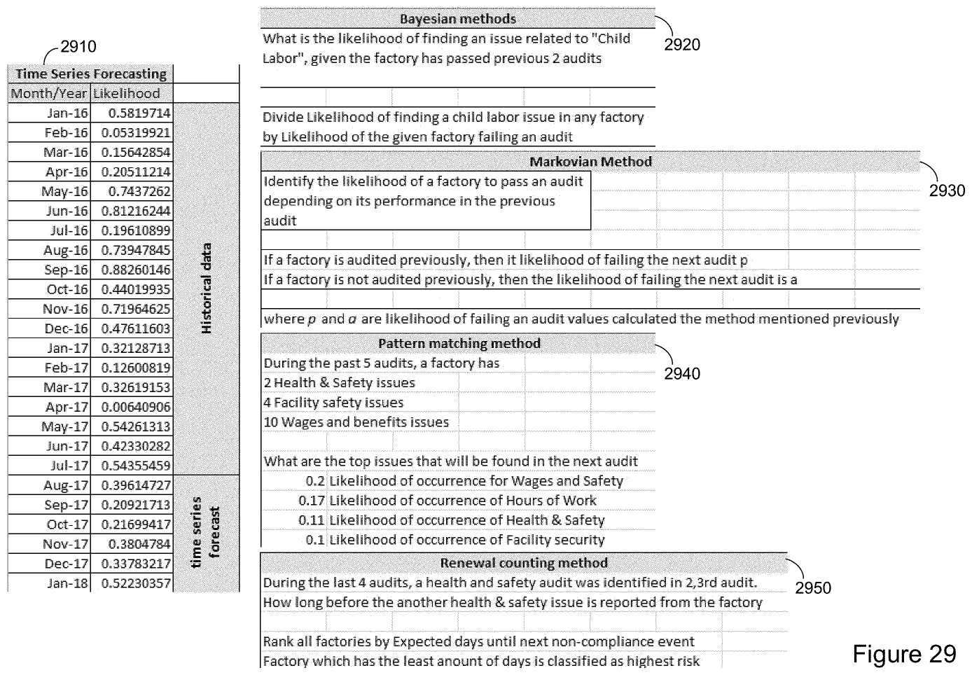

FIG. 11 illustrates a profile of the Likelihood and Impacts Trends, showing two charts: a Trend & Forecast of Likelihood chart and a Trend of Severity chart, from Jan. 2, 2015 to Sep. 24, 2019. Each chart shows a best fit line through the charted historical data (shown in blue), up until the end date, Sep. 24, 2019. After the end date, the forecast for the likelihood of failure for a particular issue (or for any number of issues for a particular factory) is charted with a black, dotted line, surrounded in gray. The forecast may be determined by the risk-assessment system 1300 implement statistical analysis techniques (e.g., Bayesian methods, Markovian methods, pattern-matching methods, and renewal-counting methods, as described in FIG. 29) on historical audit data and calculations of the likelihood of occurrence and severity of occurrence. The left table shows where a list of factories would be listed and their corresponding likelihood of failure score, with respect to a particular issue. The bar graph for the number of assessments for years, ranging from 2015 to 2018, broken down by quarters, is shown on the right. In addition, the lower table includes issue type and the corresponding likelihood of occurrence for years, ranging from 2015 to 2019. The table at the bottom of the user interface shows an issue type for particular years and their corresponding likelihood of occurrence

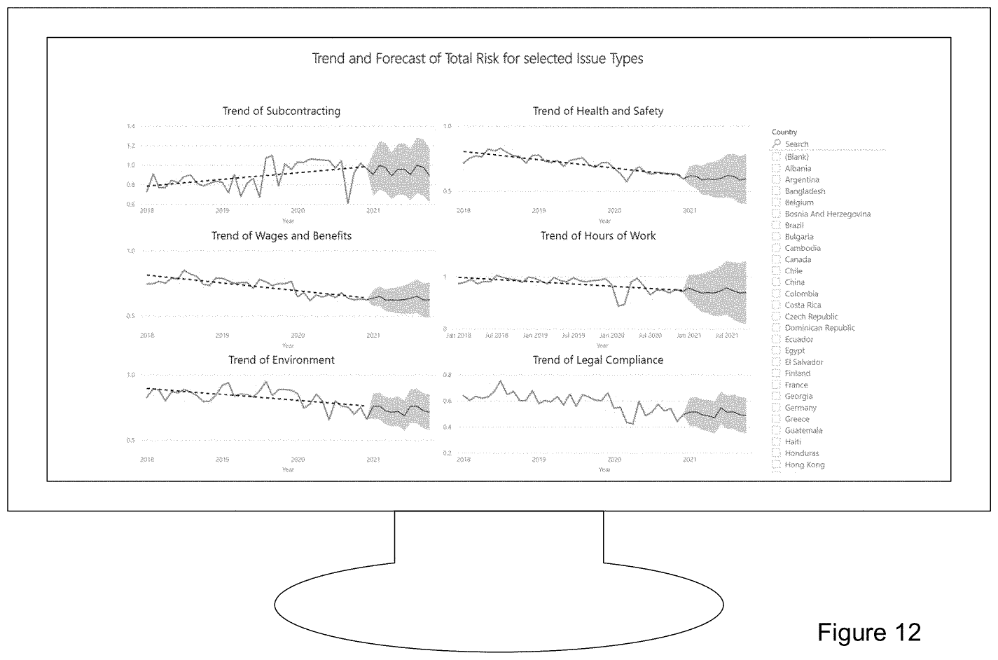

FIG. 12 illustrates a profile for the Trend and Forecast of Total Risk for Selected Issue Type. As shown, the forecasts for selected issues, including subcontracting, wages and benefits, environment, health and safety, hours of work, and legal compliance, begin at approximately 2021 and the forecast continues for approximately a year. Further shown in FIG. 12, is an option to refine each graph according to countries.

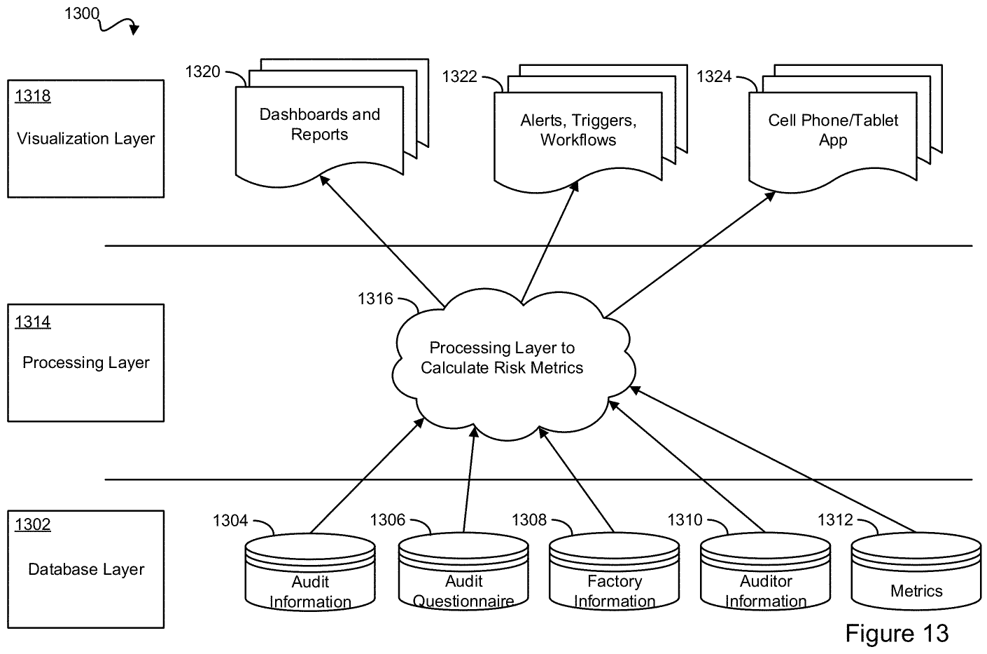

FIG. 13 illustrates the risk-assessment system 1300 architecture, including a database layer 1302, a processing layer 1314, and a visualization layer 1318. The database layer 1302 includes audit information 1304, audit questionnaires 1306, factory information 1306, auditor information 1308, and metrics 1310 that may be used to index the information included within the database layer 1302 and create a question/severity map and constraints for the processing layer 1314 to calculate the likelihood and severity of an occurrence. In some embodiments, all of the data in the database layer 1302, output from the processing layer 1314 to the visualization layer 1318, may be stored within a single warehouse, multiple warehouses, etc. The processing layer 1314 may be a remote server or cloud processing architecture and calculates risk metrics 1316, such as utilizing statistical analysis (as discussed in FIG. 29) to forecast a likelihood of an occurrence, according to a criteria (e.g., issue type, country, city, factory, auditor, year range, etc.). The processing layer 1314 may be a combination of using the data model, data relationships, and metric creation.

The processing layer 1316 outputs data to the visualization layer 1318, which includes dashboards and reports 1320; an alerts, triggers, workflows 1322; and a cell phone/tablet application 1324. The cell phone/tablet application 1324 may run on any smart device (e.g., smart phones, laptops, desktops, etc.) and may graphically display any dashboards and reports (e.g., as illustrated in FIGS. 1-12) created within the visualization layer 1318. Further the cell phone/tablet application 1320 may receive any alerts, triggers, workflows 1322 generated within the visualization layer 1318 for particular dashboards and reports 1320 generated by the phone/tablet application 1320 and displayed within the user interface. For example, the cell phone/tablet application 1324 may display a report associated with a particular factory within a supply chain that an authorized user of the cell phone/tablet application 1324 has requested to receive reports of any factory that has an update within the supply chain. Further, the report may have been generated from the processing layer 1314 processing the submitted audit information 1304, audit questionnaire 1306, factory information 1308, and/or auditor information 1310, any of which may have been submitted by an auditor (not shown) (e.g., using the cell phone/table application 1324). All of the data processed within the data processing layer 1314 is available to the user in the form of dashboards and reports, e.g., on a website, application, etc. The triggers and workflows may be tied to the dashboards and reports. If a threshold for a severity of occurrence or a likelihood of occurrence is satisfied, e.g., by exceeding a percent threshold (30%, 40%, 70%, etc.) an alert or report may be sent to a user with the application.

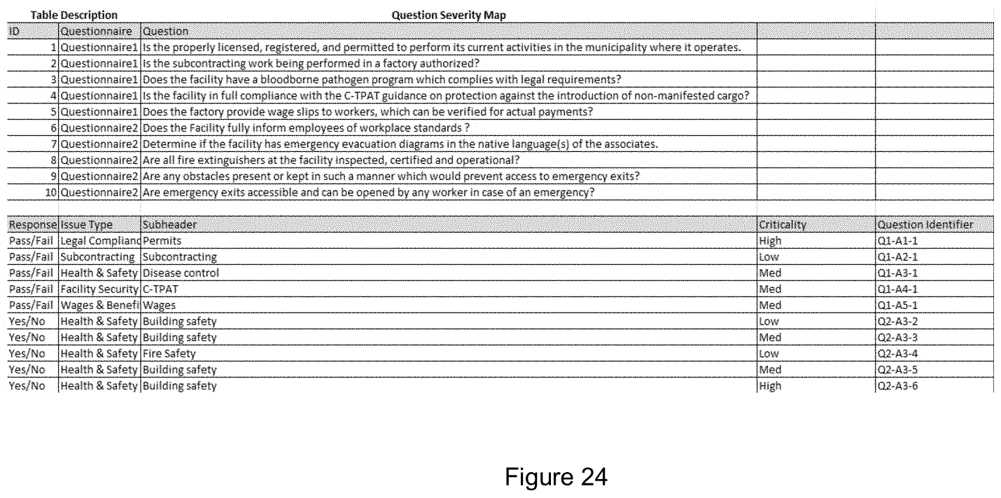

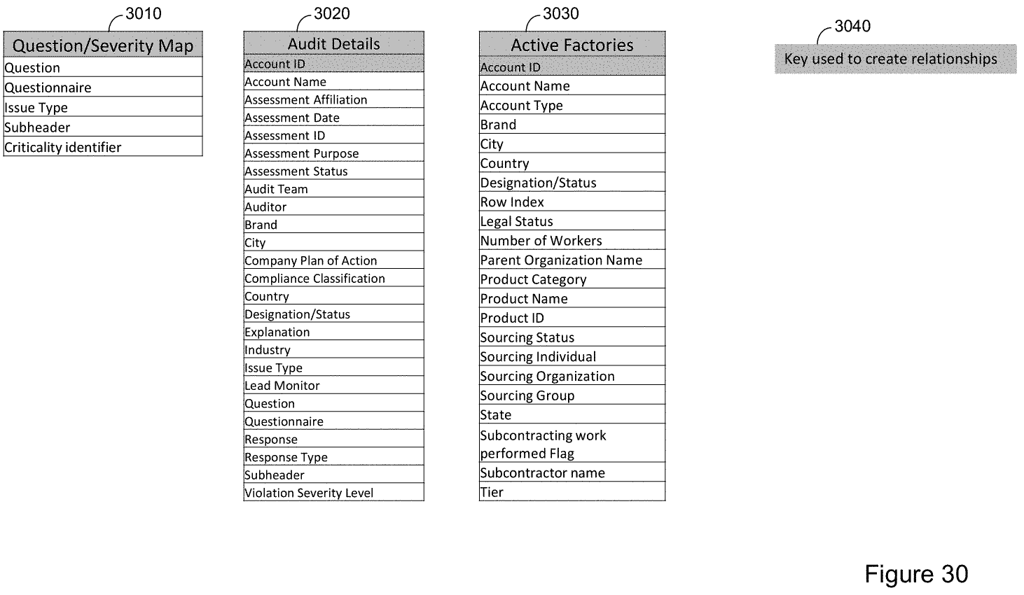

The following FIGS. 14-23 describes how the risk-assessment system 1300 ingests information, processes the information according to predetermined criteria (e.g., a format for the questionnaire), and then generates a dashboard or report for display (the interactive dashboards, as illustrated in FIGS. 1-12), using an application (e.g., cell phone/tablet application), within a user interface. FIG. 14 shows a process 1400 for the risk-assessment system 1300 generating a question/severity map that indexes the questionnaires (e.g., audit questionnaire 1306) submitted by the auditors. In some embodiments, each step within process 1400 may be accomplished by the processing layer 1314. Process 1400 includes the risk-assessment system 1300 identifying (1410) questionnaires (e.g., within the database layer 1302) used for an assessment. Each questionnaire may be in the form of a table (e.g., as shown in FIGS. 24 and 30), including columns and rows, where the rows are a particular question and the columns include a response to the question (e.g., pass/fail, yes/no, etc.), an identifier for the question (e.g., a number), and account ID, an auditor ID, country, city, factory, notes, and other information relating to the question.

Process 1400 further includes the risk-assessment system identifying (1420) individual questions within the questionnaire. Process 1400 further includes the risk-assessment system 1300 mapping (1430) questions to sub-headers (e.g., the sub-headers, with reference to FIGS. 8 and 9). Process 1400 further includes the risk-assessment system 1300 mapping (1440) the sub-headers to issue types (e.g., the issue types discussed with reference to FIGS. 1-12). For example, the sub-headers for child labor, child labor and juvenile labor, are mapped to the issue, child labor. Process 1400 further includes the risk-assessment system 1300 generating (1450) an indicator for a degree of severity of violating the mapped issue types. For example, the severity may include designating the violation as either a low, moderate, or high violation (e.g., with reference to FIG. 9). For example, child labor is a high severity and a violation of subcontracting may be a low severity. Process 1400 further includes the risk-assessment system 1300 generating (1460) a unique identifier (e.g., as described with reference to FIGS. 24-28) for each question. For example, the unique identifier may be a concatenation of multiple columns from the submitted questionnaire, e.g., ‘question-response-severity-issue type-etc.’ and may include any permutation of identifying information to tie the unique question identifier to the question.

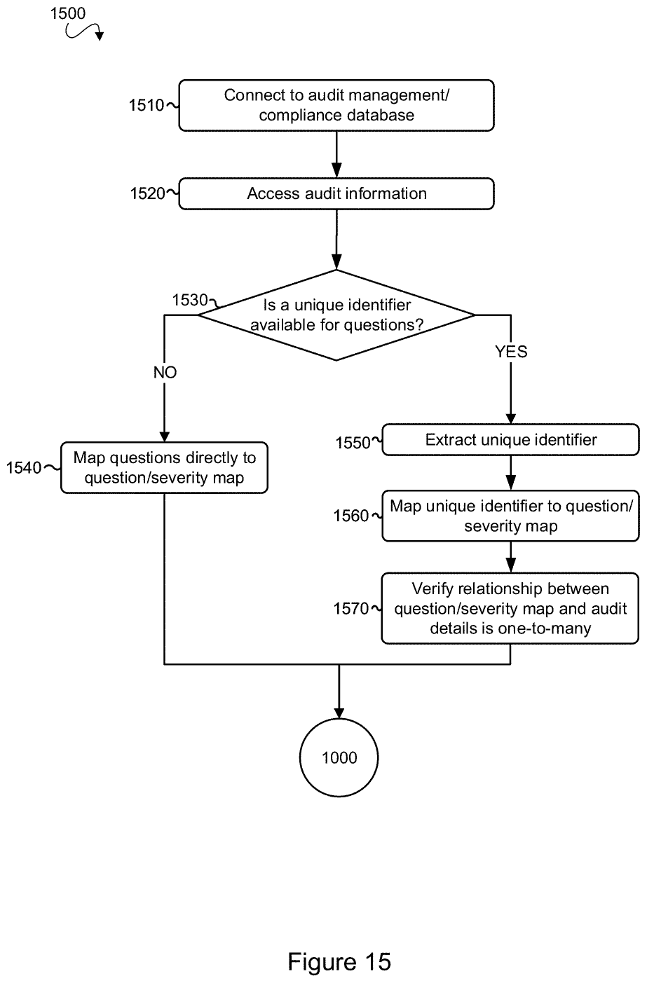

FIG. 15 illustrates a process 1500 of mapping audit details (FIG. 30) from the questionnaire to a question/severity map. The process 1500 uniquely identifies and creates an index for each response for a question of the audit. The process 1500 further includes the risk-assessment system 1300 connecting (1310) to an audit database (e.g., the audit information 1304 or any database within the database layer 1302). The process 1500 further includes the risk-assessment system 1300 accessing (1320) audit information (e.g., the audit information 1304). For example, the processing layer 1314 may identify the information from the audit questionnaire 1306 and then access information from the audit information 1304. The process 1500 further includes the risk-assessment system 1300 determining (1320) whether a unique identifier is present for a particular question by accessing various aspects of a question that may be unique. In some embodiments, a client may label individual questions themselves and/or create a unique question identifier themselves. If the risk-assessment system determines that the unique identifier is not present for the particular question decision branch: “NO”), the process 1500 may further include the risk-assessment system mapping questions directly to the question/severity map.

However, if the risk-assessment system 1300 determines that a unique identifier is available for the particular question (decision branch: “NO”), the process 1500 may further include the risk-assessment system extracting (1550) the available unique identifier. The process 1500 further includes the risk-assessment system 1300 mapping (1560) the extracted, unique identifier to the question/severity map. The process 1500 further includes the risk-assessment system 1300 verifying (1570) that the relationship between the question/severity map and audit details is one-to-many, meaning one question on the question/severity map will have many responses (e.g., from the audit details, FIG. 30, for the particular question). After this, the process 1500 may continue, from steps (1540) and (1570), to 1000.

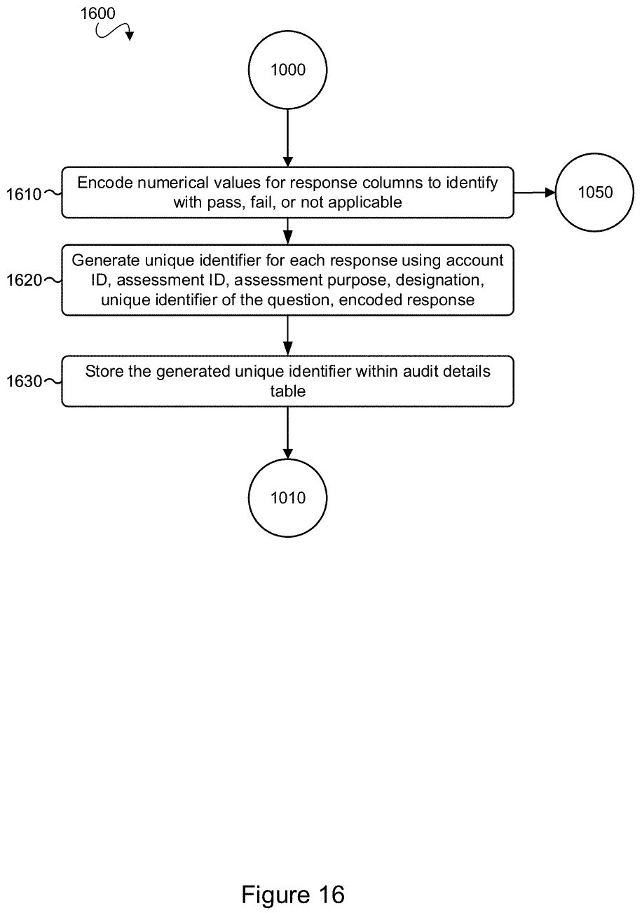

FIG. 16 illustrates a process 1600 of the risk-assessment system 1300 uniquely identifying each response (e.g., ‘pass’, ‘fail’, or ‘not applicable’) for a particular question within an audit. Process 1600 includes the risk-assessment system 1300 receiving the data from 1000 and encoding (1610) numerical values for response columns to identify with a ‘pass’, ‘fail’, or ‘not applicable’. Process 1600 may continue with 1050, from step 1610. Process 1600 further includes the risk-assessment system 1300 generating (1620) a unique identifier for each response using account ID, assessment ID, assessment purpose, designation (e.g., the status of the factory post audit), unique identifier of the question, and encoded response. Process 1600 further includes the risk-assessment system 1300 storing (1630) the generated unique identifier within the audit-details table. Further, process 1600 may continue to 1010.

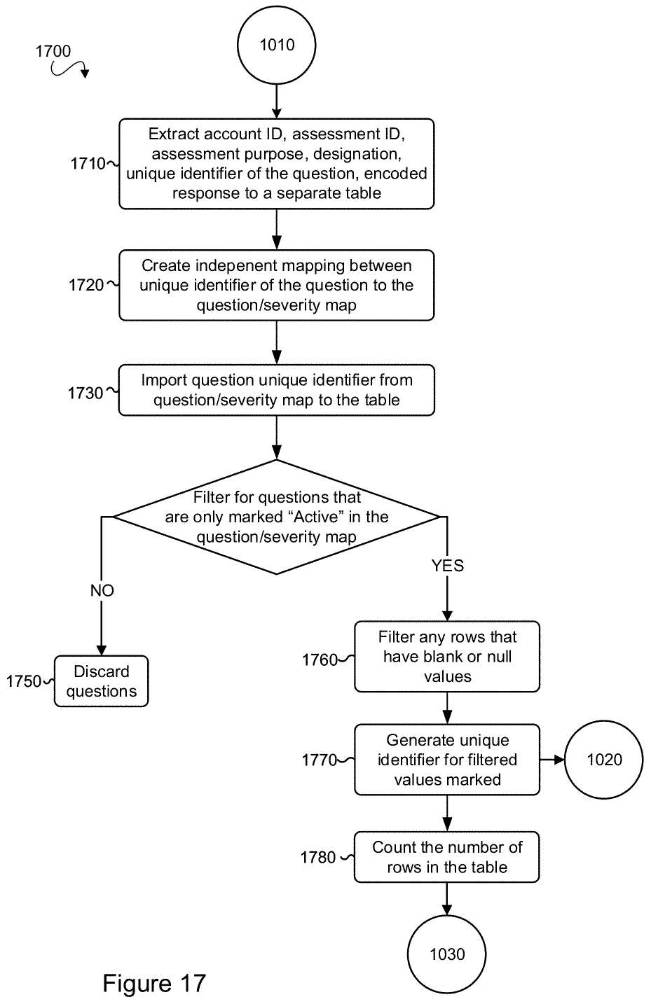

FIG. 17 illustrates a process 1700 of continuing from 1010, and includes discarding questions that do not include certain questions (e.g., questions that include a response, “not applicable”, or any portion of the unique identifier, etc.) and calculating a risk metric for the likelihood of occurrence. Further, process 1700 includes the risk-assessment system 1300 extracting (1710) an account ID, assessment ID, assessment purpose, designation, unique identifier of the question, and encoded response to a separate table. Process 1700 further includes the risk-assessment system 1300 creating (1720) an independent mapping between the unique identifier of the question to the question/severity map. Further, process 1700 includes the risk-assessment system 1300 importing (1730) the unique question identifier from the question/severity map to the table.

Process 1700 further includes the risk-assessment system 1300 filtering for questions that are only marked “Active” in the questions/severity map. In some embodiments, the risk-assessment system assigns a fail-safe for the likelihood of occurrence for the filtered questions. If the risk-assessment system 1300 determines (1740) whether a question is “Inactive” (branch decision: “NO”), the process 1700 further includes the risk-assessment system 1300 discarding (1750) those questions. However, if the risk-assessment system 1300 determines a question is marked “Active” (decision branch: “YES”), the process 1700 further includes the risk-assessment system 1300 filtering any rows of the table that have blank or null values. Process 1700 continues with the risk-assessment system 1300 generating (1770) a unique identifier for the filtered values that are marked as “Active”. The process 1700 further includes the risk-assessment system 1300 then continuing to 1020. The process 1700 further includes the risk-assessment system 1300 counting (1780) the number of rows in the table for the unique identifiers.

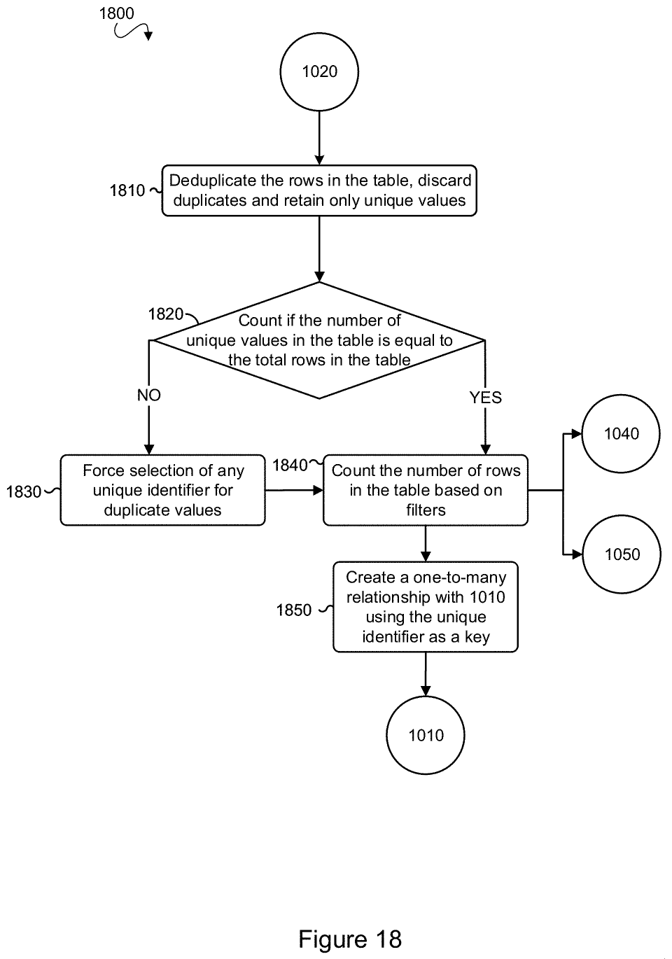

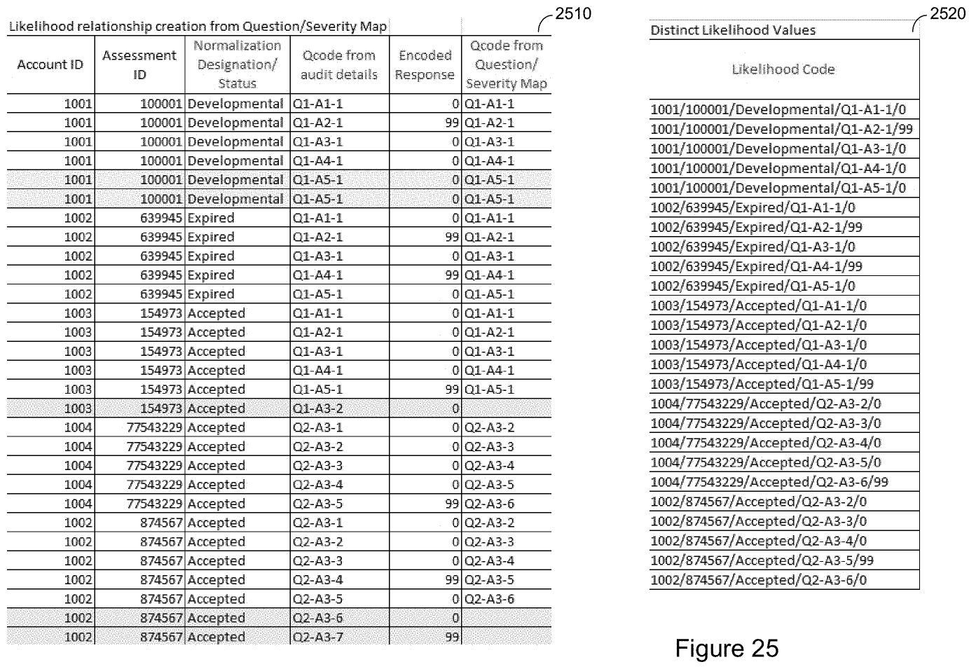

FIG. 18 illustrates a process 1800 of calculating a risk metric for the likelihood of occurrence. The process 1800 may include the risk-assessment system 1300 deduplicating (1810) the rows in the table, discarding the duplicates, and retaining only the unique values (e.g., as described in more detail in FIG. 25). The process 1800 may further include the risk-assessment system 1300 determining (1820) whether the number of unique values in the table is equal to the rows in the table. For example, the risk-assessment system 1300 may determine this by counting the number of unique values in the table and the number rows in the table, and determining if there is a difference between the two values. If the risk-assessment system 1300 determines the difference between the two values is a nonzero value (decision branch: “NO”), the process 1800 may continue with the risk-assessment system 1300 forcing (1830) a selection of any unique identifier for duplicate values identified in the table. However, if the risk-assessment system 1300 determines the difference between the two values is zero (decision branch: “YES”), the process 1800 may continue with the risk-assessment system 1300 counting (1840) the number of rows in the table based on the filters. From step 1840, process 1800 may continue to 1040 and 1050. Process 1800 may continue with the risk-assessment system 1300 creating (1850) a one-to-many relationship with the information from 1010 using the unique identifier as a key, and then continue to 1010.

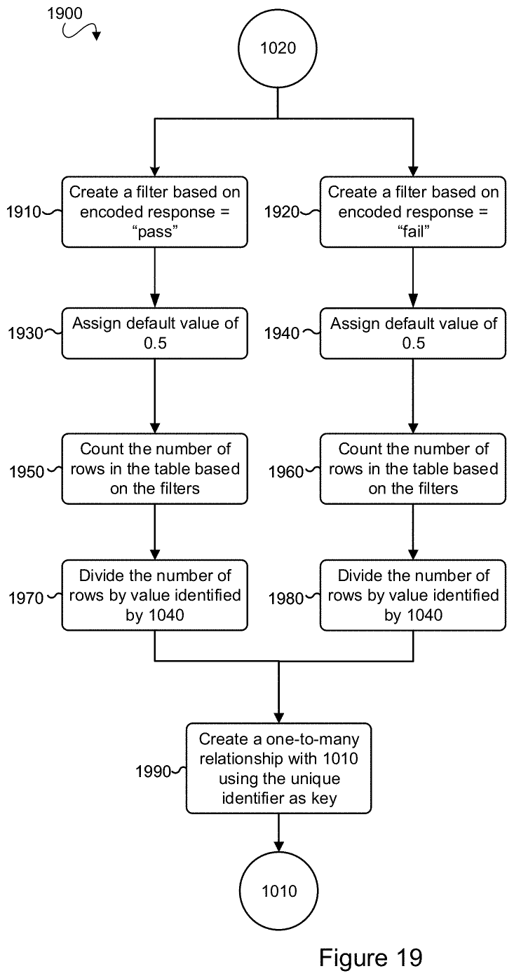

FIG. 19 illustrates process 1900 continuing with the risk-assessment system 1300 calculating the risk metric for a “likelihood of occurrence” by filtering the unique identifiers by the responses, “pass” or “fail” (e.g., as described with reference to FIGS. 24-28). From process 1900, two tables will be created: one for the response: “pass” and one for the response: “fail”. Process 1900 may start at 1020, with the risk-assessment system 1300 creating (1910) a filter based on the encoded response of “pass” and creating (1920) a filter based on the encoded response of “fail”. The process 1900 may continue with the risk-assessment system 1300 assigning (1930), (1940) a default value of 0.5 for any value that is not calculated (e.g., when a response has not been completed) so not to introduce a bias, because a response has a 50 percent chance of being a “pass” or “fail”. Process1900 may continue with the risk-assessment system 1300 counting (1950), (1960) the number of rows in the table for the filtered responses of “pass” and for the filtered responses of “fail”. Process 1900 may continue with the risk-assessment system 1300 dividing (1970), (1980) the number of rows by the value identified in 1040 (the number of rows that have been filtered out). Further, in steps (1970), (1980), the risk-assessment system passes the value of −9.99 if the denominator from the starting point 1040 is zero, as a fail-safe. Process 1900 may continue with the risk-assessment system 1300 creating (1990) a one-to-many relationship with 1010 using the unique identifier as a key. Following this, the process 1900 may continue to 1010. From this calculation, the risk-assessment system 1300 can select (e.g., based on user-input, as described with reference to FIGS. 1-12) any unique identifier and calculate the likelihood of occurrence value for a particular assessment ID, auditor, factory, or any column within the questionnaire submitted to the database layer 1302 (FIG. 13).

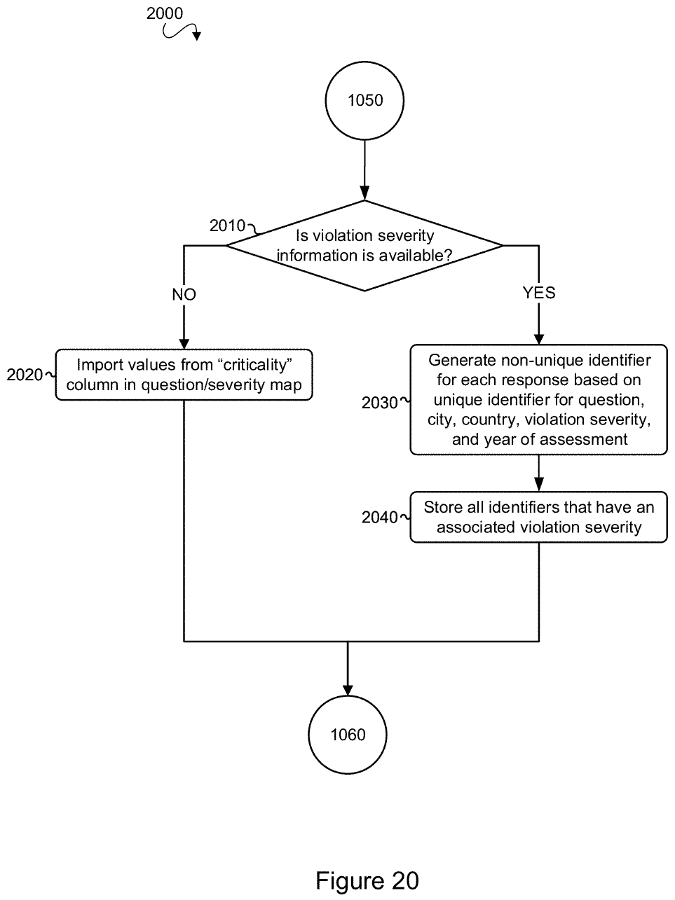

FIG. 20 illustrates the process 2000 for the risk-assessment system 1300 calculating the risk metric to create a value for a “severity of occurrence”. In some embodiments, the severity of occurrence may be grouped by countries and, because laws vary by country, one violation may be within the confines of the country's laws, whereas the same violation may not be within the confines of another country's laws (e.g., legal work hours). Further, a violation may be legal in a country, yet considered a human-rights violation on an international scale. In some embodiments, the risk-assessment system 1300 may determine a metric in the form of a numerical value (e.g., 0.33, 0.66, 1) for each severity level. For example, the risk-assessment system 1300 assigns the severity levels as low (0.33), moderate (0.66), high (1). Further, aggregating the severity of an occurrence for within a country, the system can distinguish between a high severity issue that occurred once and a low severity issue that is systematic.

Process 2000 may begin at 1050 (FIG. 18), after the risk-assessment system 1300 has counted the number of rows based on the filtering of process 1800. Then, process 2000 may continue with the risk-assessment system 1300 determining (2010) whether violation severity information is available for a particular violation. If the risk-assessment system 1300 determines there is no violation severity information available (decision block: “NO”), the process 2000 continues with the risk-assessment system 1300 importing (2020) values for a severity violation from a “criticality” column in the question/severity map. The process 2000 may then proceed to 1060. However, if the risk-assessment system 1300 determines there is violation severity information available (decision block: “YES”), the process 2000 continues with the risk-assessment system 1300 generating (2030) a non-unique identifier for each response based on a unique identifier for ‘question’, ‘city’, ‘country’, ‘violation severity’, and ‘year of assessment’. The process 2000 may continue with the risk-assessment system 1300 storing (2040) storing all identifiers that have an associated violation severity. The process 2000 may then proceed to 1060.

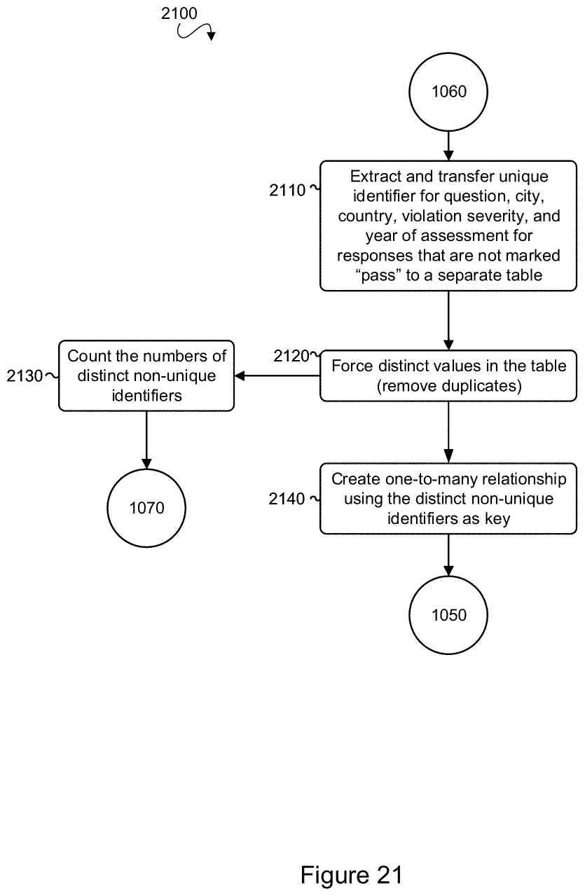

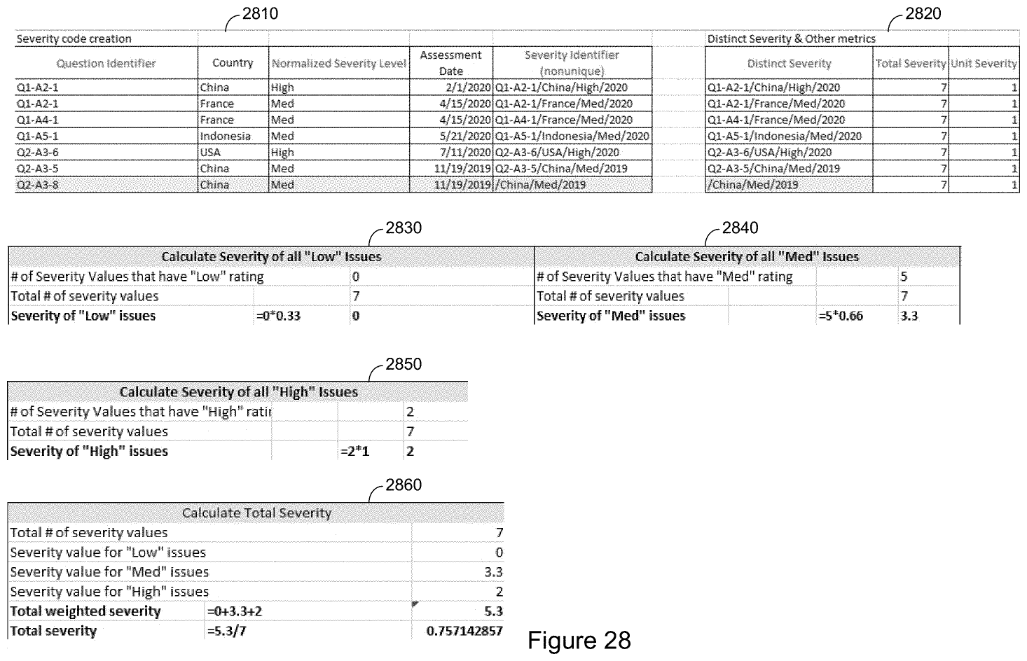

FIG. 21 illustrates a process 2100 for the risk-assessment system 1300 continuing to calculate the severity of occurrence for only the stored identifiers that have an associated violation severity (as described below, with reference to at least FIG. 28). The process 2100 includes the risk-assessment system 1300 extracting and transferring (2110) unique identifiers for ‘question’, ‘city’, ‘country’, ‘violation severity’, and ‘year of assessment’ for responses that are not market “pass” to a separate table. The process 2100 continues with the risk-assessment system 1300 forcing (2120) distinct values in the table (removing duplicates). For example, there may be four different assessments within the same country that identify the same violation. In this case, the risk-assessment system will remove the duplicate (three of the four identifiers) identifiers so not to inflate the calculated severity value for the violation. The process 2100 may continue with the risk-assessment system 1300 counting (2130) the numbers of distinct non-unique identifiers. The process 2100 may then continue to 1070. The process 2100 continues with the risk-assessment system 1300 creating (2140) creating a one-to-many relationship using the distinct non-unique identifiers as key. The process 2100 may then continue to 1050.

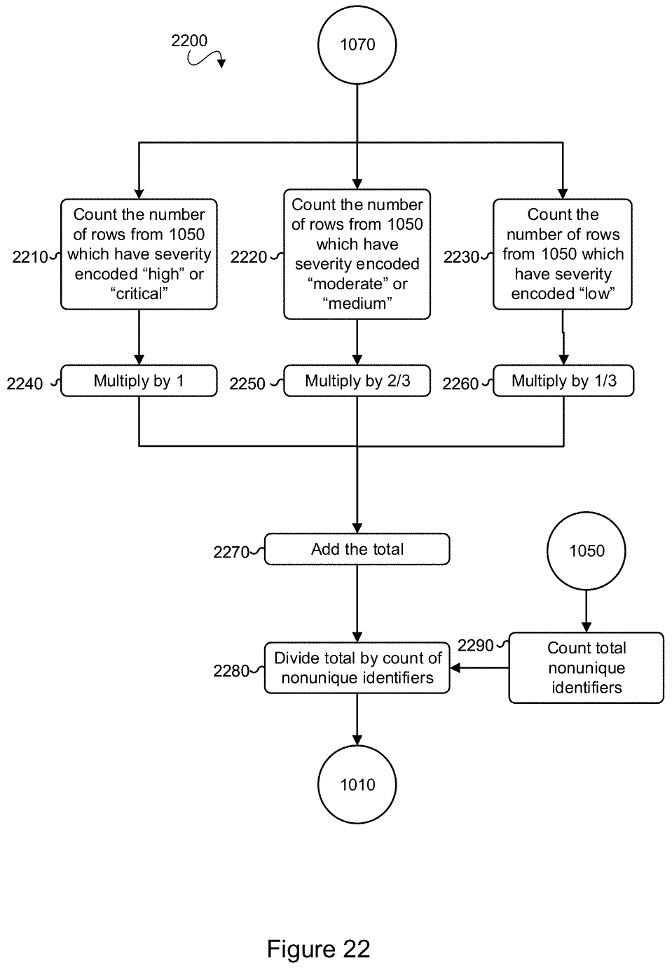

FIG. 22 illustrates a process 2200 for the risk-assessment system 1300 to calculate a weighted sum of the aggregated severity level by multiplying numerical values with the severity level of a violation and adding the individual multiplied values (as described below, with reference to at least FIG. 29). The process 2200 includes the risk-assessment system 1300 counting (2210), (2220), (2230) the number of rows from 1050 which have a severity level encoded “high” or “critical”, “moderate” or “medium”, or “low”, and multiplying (2240), (2250), (2260) those values by either, 1, 0.67, or 0.33, respectively, depending on the level of encoded severity. The process 2200 continues with the risk-assessment system 1300 adding (2270) the total from the multiplied values. The process 2200 may then continue with the risk-assessment system 1300 dividing (2280) the added total by the total number of counted (2290) values of nonunique identifiers, received from 1050. The process 2200 may continue by transmitting this value to 1010.

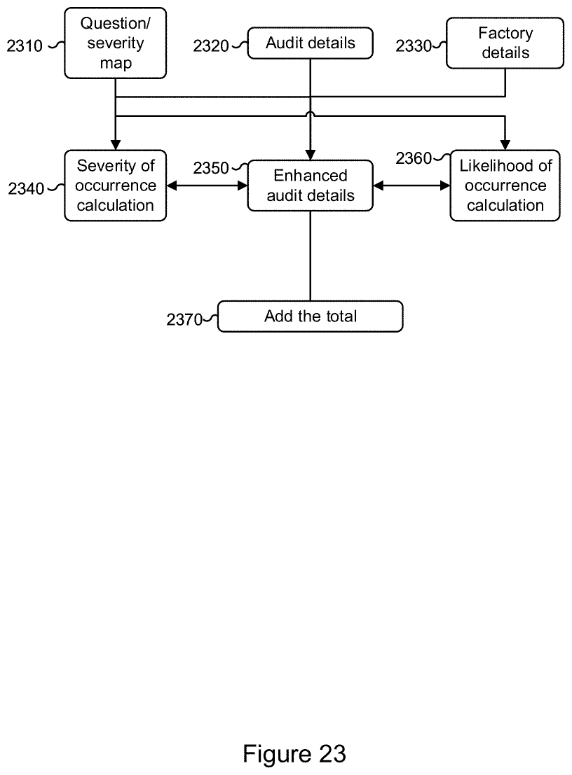

FIG. 23 illustrates an entity relationship diagram 2300 that details how many one-to-many relationships the risk-assessment system 1300 creates. Entity relationship diagram 2300 begins with the question/severity map (2310), the audit details (2320), and the factory details (2330). The entity relationship diagram 2300 then enhances (2350) the audit details, e.g., by creating a question identifier, filtering the duplicate question identifiers, and setting up the questions to create a table to calculate the severity of occurrence (2340) and the likelihood of occurrence (2360). Further, the entity relationship diagram 2300 transfers information used to create the question/severity map (2310) to calculate the severity of occurrence (2340) and to calculate the likelihood of occurrence (2360). The entity relationship diagram 2300 then uses the enhanced audit details (2350) to create a virtual table of the audit findings (2370), where all the results from the previous tables, such as the severity of occurrence table (2340) and the likelihood of occurrence table (2360), are displayed.

The following FIGS. 24-29 describe a more detailed discussion of the calculations of the likelihood of occurrence and the severity of the occurrence, as discussed above. FIG. 24 illustrates a table for the question severity map, that includes ID, questionnaire, question, response, issue type, sub-header, criticality, and question identifier columns. FIG. 25 shows a table 2510 for the likelihood relationship created from the question/severity map, that includes account ID, assessment ID, normalization designation/status, Qcode (question code) from audit details, encoded response, and Qcode from question/severity map columns. FIG. 25 further shows a table 2520 of the distinct likelihood values (likelihood codes). Table 2510 further shows rows that are redundant or that have no Qcode from the question/severity map; these rows are filtered by the risk-assessment system 1300, as discussed above. The table 2520 is the result of the filtering from table 2510.

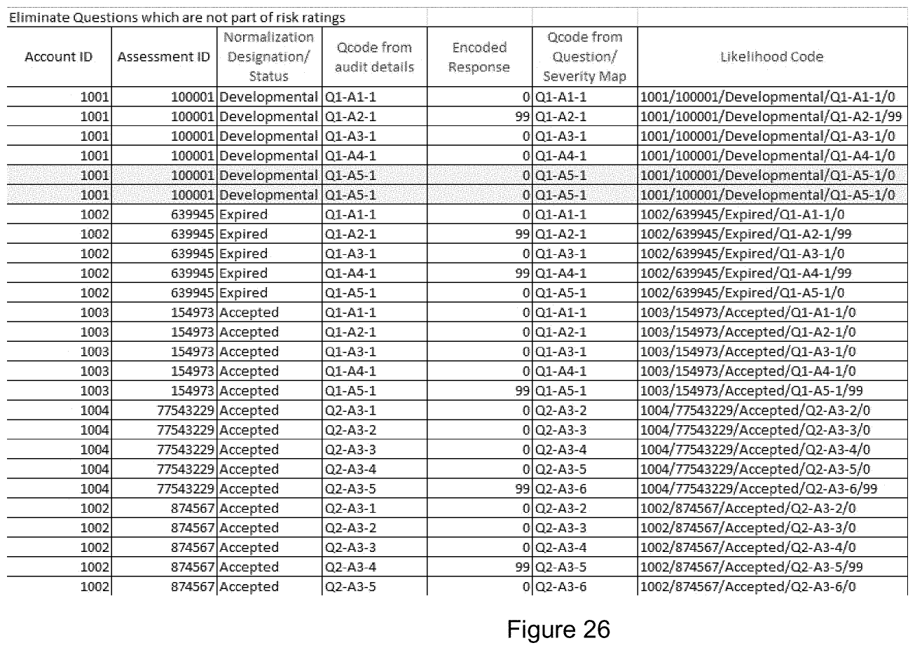

FIG. 26 illustrates a table that is a result of filtering table 2510 to remove the rows without a likelihood code. The highlighted rows are redundant.

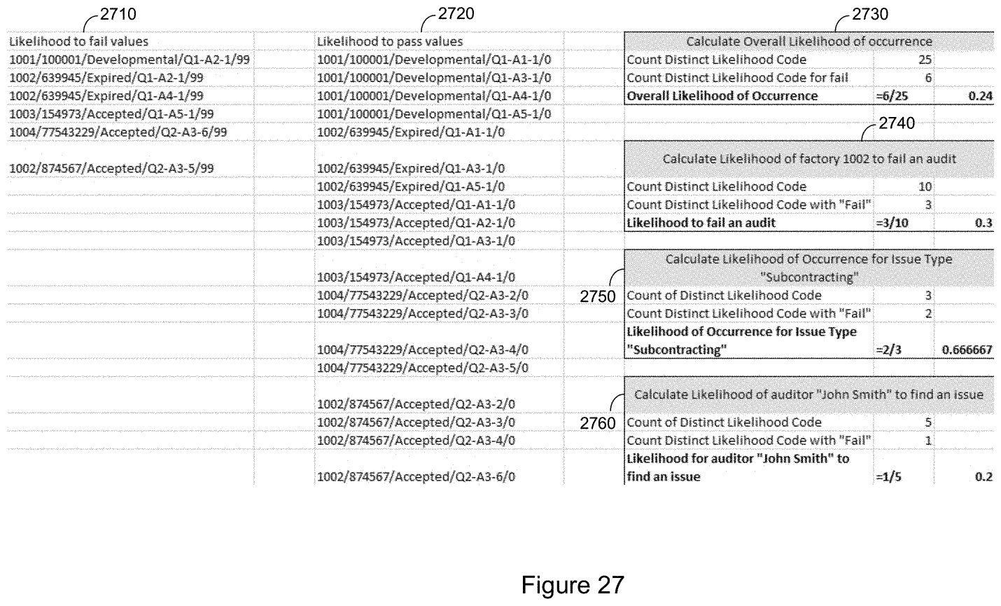

FIG. 27 illustrates multiple tables used by the risk-assessment system 1300 to calculate an overall likelihood of occurrence and a severity of occurrence, with respect to a criteria. The overall likelihood of occurrence, as shown in table 2730, is 0.24, which was calculated by dividing the number of “fail” values 2710 (i.e., 6) by the total number of “pass” values 2720 (i.e., 25), for a value of 0.24. The likelihood of occurrence can be tailored for specific factories. For example, to calculate the likelihood of factory 1002 failing an audit, as shown in table 2740, the number of distinct likelihood codes with a “fail” for factory 1002 (i.e., 3) is divided by the total number of distinct likelihood codes for factory 1002 (i.e., 10), as shown in table 2740, for a total of 0.3. Similarly, with reference to table 2750, the risk-assessment system 1300 can calculate the likelihood of occurrence for a particular issue type, “subcontracting”, by dividing the total counted number of distinct likelihood codes with “subcontracting” with a “fail” response (i.e., 2) by the total of distinct likelihood codes with “subcontracting” (i.e., 3), to arrive at a value of 0.667. Further, with reference to table 2750, the risk-assessment system 1300 can calculate the likelihood of an auditor “John Smith” finding an issue by counting the number of distinct likelihood codes audited by ‘John Smith” (i.e., 5) and counting the number of distinct likelihood codes audited by “John Smith” and resulting in a “fail” (i.e., 1), and then dividing those values for a likelihood value of 20 percent.

FIG. 28 illustrates the tables used by the risk-assessment system 1300 in calculating a severity of occurrence score, as discussed above. FIG. 28 illustrates a severity code creation table 2810 that includes columns for questions identifiers, country, normalized severity level, assessment date, and a non-unique severity identifier. The normalized severity level may be a severity level determined by a client or other authorized personnel, and may be determined based on a severity level that is not particularly severe to a country but severe to the authorized personnel. For example, if a country's laws allow an action, but many other countries or an international norm still regard the action as a human-rights violation, the authorized personnel may determine that the normalized severity level is high. However, a country's laws may be strict in comparison to the rest of the world, so the authorized personnel may determine that to normalize the severity level to low or moderate. FIG. 28 further illustrates a distinct severity & other metrics table 2820 that includes distinct severity, total severity, and unit severity columns.

Each of the normalized severity levels (e.g., low, med, and high) may be multiplied by a corresponding numerical value (e.g., 0.33, 0.67, and 1), respectively. Table 2830 shows the calculation of the severity of all “Low” issues, the number of “Low” severity levels (0), multiplied by 0.33, equaling 0. Table 2840 shows the calculation of the severity of all “Med” issues, the number of “Med” severity levels (5), multiplied by 0.67, equaling 3.3. And table 2850 shows the calculation of the severity of all “High” issues, the number of “High” severity levels (2), multiplied by 2, equaling 2. Table 2860 shows the total severity level by adding up the totals from tables 2830, 2840, and 2850, and then dividing by the total number of severity scores (7), with a total weighted severity score of 0.76.

FIG. 29 illustrates the various ways the risk-assessment system may utilize statistical techniques to forecast a likelihood of occurrence for a particular issue for a range of time, as described in FIGS. 11 and 12. Table 2910 shows time-series forecasting for months, ranging from January 2016 to January 2018. The historical data ranges from January 16 to July 17, and the time-series forecast ranges from August 17 to July 17. The risk-assessment system 1300 may determine the time-series forecast using Bayesian methods (table 2920), Markovian methods (table 2930), pattern-matching methods (table 2940), and renewal-counting methods (table 2950).

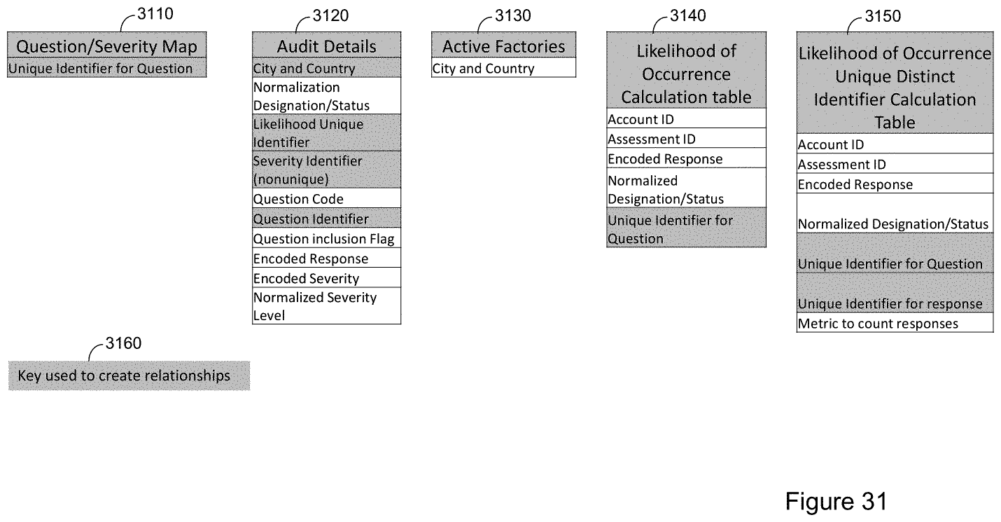

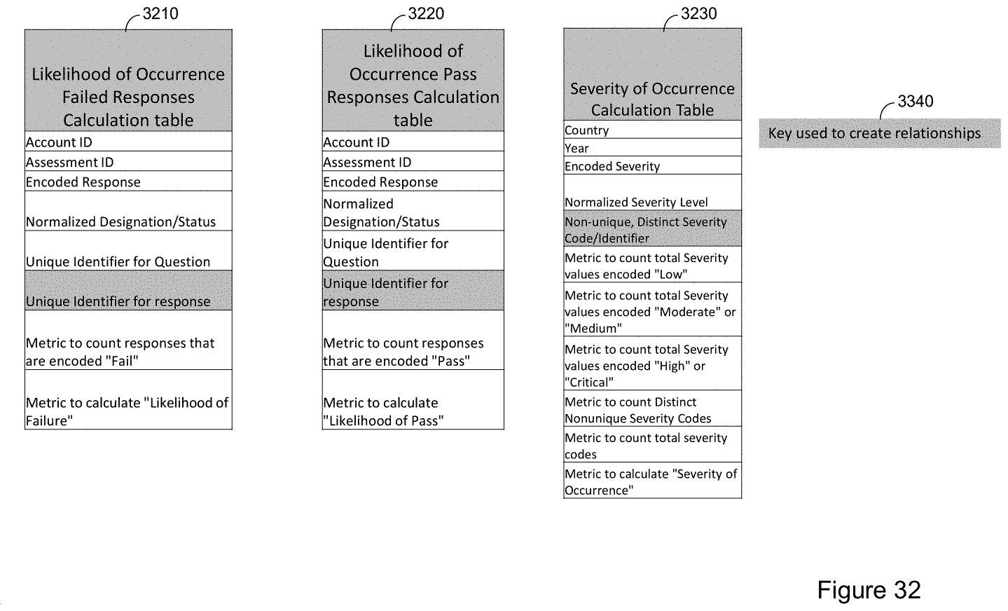

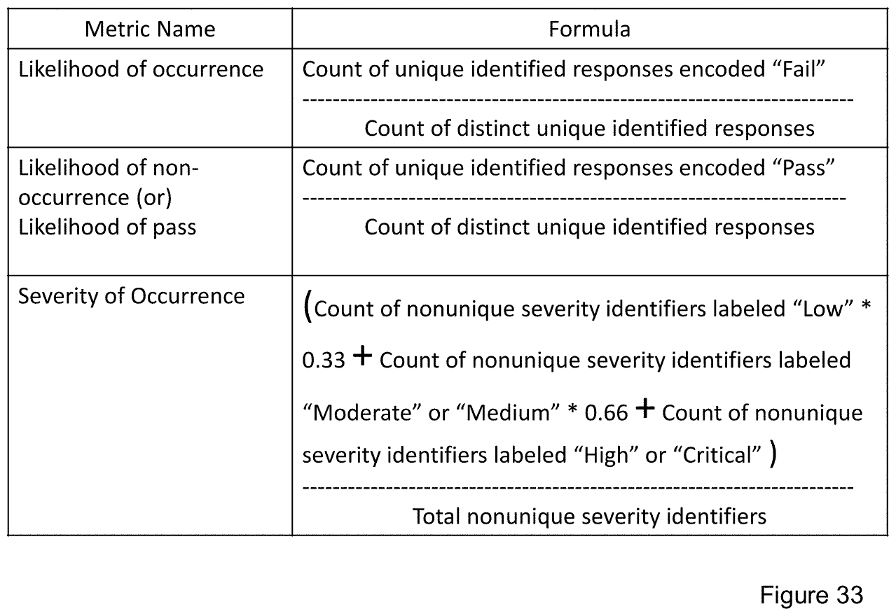

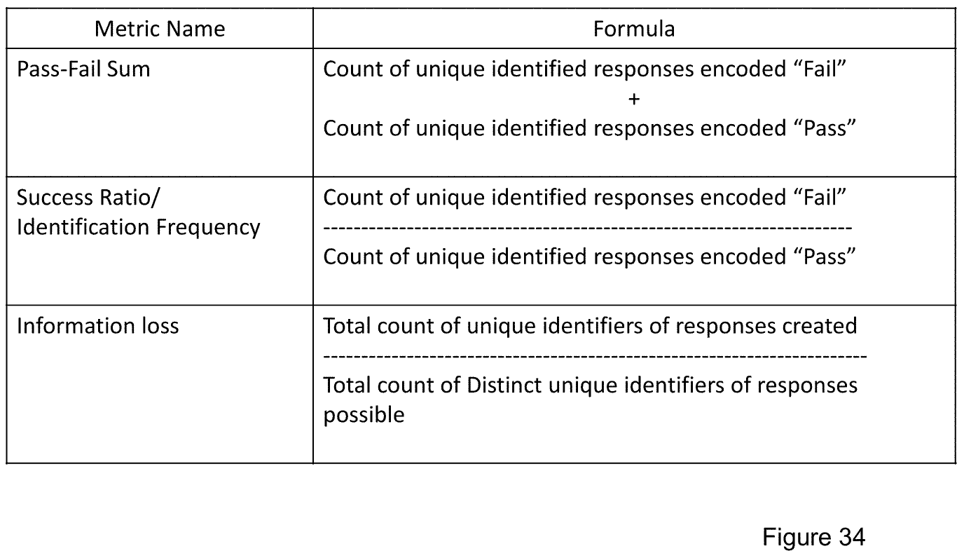

FIG. 30 shows multiple tables created and used in the calculations of the likelihood of occurrence and the severity of occurrence, as discussed above (with respect to various processes), including a question/severity map 3010, audit details 3020, active factories 3030, and the key 3040 that is used to create relationships between the tables. FIG. 31 shows multiple tables used by the risk-assessment system 1300 to calculate the likelihood of occurrence, as discussed above, including the question/severity map 3110, audit details 3120, active factories 3130, the likelihood of occurrence calculation table 3140, the likelihood of occurrence unique distinct identifier calculation table 3150, and the key 3160. FIG. 32 shows multiple tables used by the risk-assessment system 1300, after filtering the “failed” responses from the “pass” responses, to calculate the severity of occurrence, as discussed above. The tables include a likelihood of occurrence (with “failed” responses) calculation table 3210, a likelihood of occurrence (with “pass” responses) calculation table 3220, a severity of occurrence calculation table 3230, and a key 3240 used to create the relationships between the tables 3210, 3220, and 3230, which are the rows with a ‘unique identifier for response’ for tables 3210, 3220 and the ‘non-unique, distinct severity code/identifier’ for table 3230. FIG. 33 shows the metric name and the associated formula for calculating the particular metric, as discussed above. FIG. 34 shows a metric name and an associated formula for calculating the particular metric, as discussed above.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for identifying risk of noncompliance in a supply chain, comprising:
ingesting, by a risk-assessment system, audit data corresponding an entity, the audit data being in the form of one or more questionnaires;
formatting, by the risk-assessment system, the audit data according to a predetermined format where each question within a questionnaire is assigned a corresponding unique code;
indexing, by the risk-assessment system, the corresponding unique code for each question of the questionnaire;
generating, by the risk-assessment system, a question identifier that includes a concatenation of one or more unique codes for a particular question, such that every question within the questionnaire has a corresponding question identifier;
calculating, by the risk-assessment system, a likelihood of a particular violation occurring within the entity in the supply chain by dividing the number of unique identifiers for the particular violation that have a fail response by the total number of unique identifiers for the particular violation;
generating, by the risk assessment system, based on the audit data and the calculated likelihood of occurrence, an interactive dashboard; and
displaying, by the risk assessment system, the interactive dashboard within a user interface.

2. The method of claim 1, further comprising:
calculating, by the risk-assessment system, a severity of occurrence for the particular violation in the supply chain by adding a total number of events of a likelihood of the particular violation occurring, multiplying a criticality level of the severity of the violation by a corresponding numerical value, and then adding each of the multiplied values.

3. The method of claim 1, further comprising:
filtering, by the risk-assessment system, duplicative question identifiers; and
storing, by the risk-assessment system, unique question identifiers.

4. The method of claim 1, wherein the interactive dashboard includes one or more dropdown menus with one or more features to select for adjusting the interactive dashboard, further comprising:
receiving, by the risk-assessment system, input to adjust the interactive dashboard; and
modifying, by the risk-assessment system, based on the received input, the interactive dashboard.

5. The method of claim 2, wherein the interactive dashboard includes a two-dimensional graph of the likelihood of occurrence on a first axis and the severity of occurrence on a second axis.

6. The method of claim 2, wherein the criticality level is determined by receiving an input from a client, based on the audit data, or the response of the question.

7. The method of claim 2, further comprising:
generating, by the risk-assessment system, a nonunique identifier for the severity of the particular violation by concatenating the unique codes for the particular question with the unique question identifier.

8. The method of claim 1, further comprising:
receiving, by the risk-assessment system, user input to forecast the likelihood of occurrence, or other metrics derived by multiplicative, additive or divisive operations on the likelihood of occurrence with respect to a particular violation, entity, audit type, and a particular time range;
performing, by the risk-assessment system, statistical analysis techniques, on the audit data; and
forecasting, based on the risk-assessment system performing the statistical analysis techniques on the audit data, the likelihood of occurrence for the particular violation and for the particular time range.

9. The method of claim 8, wherein the statistical analysis techniques are selected from the group consisting of Bayesian methods, Markovian methods, pattern-matching method, and renewal counting method.

10. The method of claim 1, further comprising:
mapping, by the risk-assessment system, the likelihood of the particular violation occurring for the audit data formatted and indexed using the corresponding unique code for each question of the questionnaire;

11. A method for identifying risk of noncompliance in a supply chain, comprising:
ingesting, by a risk-assessment system, audit data corresponding an entity, the audit data being in the form of one or more questionnaires;
formatting, by the risk-assessment system, the audit data according to a predetermined format where each question within a questionnaire is assigned a unique code;
indexing, by the risk-assessment system, the unique code for each corresponding question of the questionnaire;
generating, by the risk-assessment system, a question identifier that includes a concatenation of one or more unique codes for a particular question, such that every question within the questionnaire has a corresponding question identifier;
calculating, by the risk-assessment system, a severity of occurrence for a violation occurring in the supply chain by adding a total number of events of a likelihood of the violation occurring, multiplying a criticality level of the severity of the violation by a corresponding numerical value, and then adding each of the multiplied values;
generating, by the risk assessment system, based on the audit data and the calculated severity of occurrence, an interactive dashboard; and
displaying, by the risk assessment system, the interactive dashboard within a user interface.

12. The method of claim 1, wherein the interactive dashboard includes one or more dropdown menus with one or more features to select for adjusting the interactive dashboard, further comprising:
receiving, by the risk-assessment system, input to adjust the interactive dashboard; and
modifying, by the risk-assessment system, based on the received input, the interactive dashboard.

13. The method of claim 11, further comprising:
receiving, by the risk-assessment system, user input to forecast the severity of occurrence, with respect to a particular violation and a particular time range;
performing, by the risk-assessment system, statistical analysis techniques, on the audit data; and
forecasting, based on the risk-assessment system performing the statistical analysis techniques on the audit data, the severity of occurrence for the particular violation and for the particular time range.

14. The method of claim 13, wherein the statistical analysis techniques are selected from the group consisting of Bayesian methods, Markovian methods, pattern-matching method, and renewal counting method.

15. The method of claim 11, further comprising:
mapping, by the risk-assessment system, the severity of occurrence for the violation to the data ingested and provided as a user input;

16. A non-transitory computer readable storage medium, storing a computer instruction, wherein the computer instruction, when executed by a computer, causes the computer to perform operations, comprising:
ingesting, by a risk-assessment system, audit data corresponding an entity, the audit data being in the form of one or more questionnaires;
formatting, by the risk-assessment system, the audit data according to a predetermined format where each question within a questionnaire is assigned a unique code;
indexing, by the risk-assessment system, the unique code for each corresponding question of the questionnaire;
generating, by the risk-assessment system, a question identifier that includes a concatenation of one or more unique codes for a particular question, such that every question within the questionnaire has a corresponding question identifier;
calculating, by the risk-assessment system, a severity of occurrence for a violation occurring in the supply chain by adding a total number of events of a likelihood of the violation occurring, multiplying a criticality level of the severity of the violation by a corresponding numerical value, and then adding each of the multiplied values;
generating, by the risk assessment system, based on the audit data and the calculated likelihood of occurrence, an interactive dashboard; and
displaying, by the risk assessment system, the interactive dashboard within a user interface.

17. The non-transitory computer readable storage medium of claim 16, further comprising computer instruction that, when executed by the computer, causes the computer to perform operations including:
calculating, by the risk-assessment system other metrics using multiplicative, additive or divisive operations on the severity of occurrence with respect to a particular violation, entity, audit type and a particular time range.

18. The non-transitory computer readable storage medium of claim 16, wherein the interactive dashboard includes one or more dropdown menus with one or more features to select for adjusting the interactive dashboard, further comprising:
receiving, by the risk-assessment system, input to adjust the interactive dashboard; and
modifying, by the risk-assessment system, based on the received input, the interactive dashboard.

19. The non-transitory computer readable storage medium of claim 16, further comprising computer instruction that, when executed by the computer, causes the computer to perform operations including:
receiving, by the risk-assessment system, user input to forecast the severity of occurrence, with respect to a particular violation and a particular time range;
performing, by the risk-assessment system, statistical analysis techniques, on the audit data; and
forecasting, based on the risk-assessment system performing the statistical analysis techniques on the audit data, the severity of occurrence for the particular violation and for the particular time range.

20. The non-transitory computer readable storage medium of claim 16, wherein the statistical analysis techniques are selected from the group consisting of Bayesian methods, Markovian methods, pattern-matching method, and renewal counting method.

21. The non-transitory computer readable storage medium of claim 16, further comprising computer instruction that, when executed by the computer, causes the computer to perform operations including:
filtering, by the risk-assessment system, duplicative question identifiers; and
storing, by the risk-assessment system, unique question identifiers.

22. The non-transitory computer readable storage medium of claim 16, wherein the interactive dashboard includes one or more dropdown menus with one or more features to select for adjusting the interactive dashboard, the non-transitory computer readable storage further comprising computer instruction that, when executed by the computer, causes the computer to perform operations including:
receiving, by the risk-assessment system, input to adjust the interactive dashboard; and
modifying, by the risk-assessment system, based on the received input, the interactive dashboard.
